(19) United States
(12) Patent Application Publication
(10) Pub. No.: US 2025/0389458 A1
(43) Pub. Date: Dec. 25, 2025

(54) Methods, Systems, and Devices for Quantifying Geothermal Heat Flux Using Vertical Temperature Profiles at Shallow Depths

(71) Applicant: Atlas Energy, LTC. CO., LLC, Columbia, SC (US)

(72) Inventors: Patrick David Duff, Columbia, SC (US); Lawrence Corlies Murdoch, Anderson, SC (US)

(21) Appl. No.: 19/278,426

(22) Filed: Jul. 23, 2025

Related U.S. Application Data
(63) Continuation of application No. 19/243,223, filed on Jun. 19, 2025.
(60) Provisional application No. 63/662,913, filed on Jun. 21, 2024.
(60) Provisional application No. 63/752,520, filed on Jan. 31, 2025.
(60) Provisional application No. 63/765,176, filed on Feb. 28, 2025.

(51) Int. Cl. F24T 50/00; F24T 10/00

(52) U.S. Cl. CPC F24T 50/00; F24T 10/00; F24T 2010/56

(57) ABSTRACT

Methods, systems, and devices for quantifying geothermal heat flux using shallow subsurface temperature measurements are provided. A method can include deploying vertical temperature probes with fiber optic sensors, strain sensors, and advective sensors at measurement sites. Time-series temperature data is then recorded, processed to determine equilibrium temperature profiles, and corrected for climate-driven signals, strain, and advection effects. Geothermal heat flux is calculated by combining the corrected temperature gradient with subsurface thermal conductivity, and a heat flux map can be generated to identify geothermal energy resources.

### CROSS REFERENCE TO PRIOR APPLICATIONS

This application is a continuation application claiming priority and benefit under 35 U.S.C. § 120 from U.S. application Ser. No. 19/243,223, filed Jun. 19, 2025, which is incorporated by reference for all purposes. U.S. application Ser. No. 19/243,223 claims priority and benefit under 35 U.S.C. § 119 from U.S. Provisional Application No. 63/662,913, filed Jun. 21, 2024, U.S. Provisional Application No. 63/752,520, filed Jan. 31, 2025, and U.S. Provisional Application No. 63/765,176, filed Feb. 28, 2025, each of which is incorporated by reference for all purposes.

### BACKGROUND

### Technical Field

This disclosure relates generally to geothermal exploration, and more particularly to the use of electronic sensors to quantify geothermal heat flux.

### Background Art

Geothermal exploration is important for evaluating the subsurface energy potential of a region. For instance, precise measurement of subsurface heat flow is necessary to gain insight into the thermal structure of the earth's crust, which influences the assessment of geothermal resources. Traditionally, temperature measurements have been collected through deep, e.g., hundreds of meters beneath the earth's surface, borehole surveys. Such surveys required these great depths into the earth to try to reduce interference from surface temperature fluctuations.

However, as one can imagine, these methods often require substantial investment to create such tremendously deep boreholes. Moreover, deep borehole surveys face logistical and environmental difficulties, which restrict the frequency and spatial coverage of such surveys. There is thus a need for improved methods, systems, and devices for quantifying geothermal heat flux within the subsurface of the earth.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system diagram in accordance with one or more embodiments of the disclosure.

FIG. 2 illustrates one explanatory vertical profile temperature probe in accordance with one or more embodiments of the disclosure.

FIG. 3 illustrates one explanatory natural advection sensor in accordance with one or more embodiments of the disclosure.

FIG. 4 illustrates one explanatory architecture for measurement control and data analysis in accordance with one or more embodiments of the disclosure.

FIG. 5 illustrates one explanatory method in accordance with one or more embodiments of the disclosure.

FIG. 6 illustrates one or more method steps in accordance with one or more embodiments of the disclosure.

FIG. 7 illustrates one explanatory geographic area of interest in accordance with one or more embodiments of the disclosure in the form of a geological terrain projection view.

FIG. 8 illustrates the explanatory geographic area of interest 700 of FIG. 7 with a plurality of measurement sites defined thereon in accordance with one or more embodiments of the disclosure.

FIG. 9 illustrates one explanatory graph depicting the historical variation in mean surface temperature over time in accordance with one or more embodiments of the disclosure.

FIG. 10 illustrates one explanatory graph estimating temperature profiles as a function of depth for different average heat flux scenarios in accordance with one or more embodiments of the disclosure.

FIG. 11 illustrates one explanatory graph estimating temperature profiles as a function of depth for different high heat flux scenarios in accordance with one or more embodiments of the disclosure.

FIG. 12 illustrates explanatory temperature measurements made by a vertical profile temperature probe in accordance with one or more embodiments of the disclosure.

FIG. 13 illustrates average temperatures obtained from a vertical profile temperature probe in accordance with one or more embodiments of the disclosure.

FIG. 14 illustrates an explanatory temperature disturbance that may temporarily result from the placement of a vertical profile temperature probe in accordance with one or more embodiments of the disclosure.

FIG. 15 illustrates explanatory depth equilibrium temperatures that can be used for assessing measurement quality in accordance with one or more embodiments of the disclosure.

FIG. 16 illustrates historical measurements of temperature versus depth at an explanatory geographic site of interest in accordance with one or more embodiments of the disclosure.

FIG. 17 illustrates one explanatory estimate of the effect of surface heating on a geographic site of interest at various depths in accordance with one or more embodiments of the disclosure.

FIG. 18 illustrates one explanatory estimate subsurface heat on a geographic site of interest at various depths after correction for both natural advection and surface heating in accordance with one or more embodiments of the disclosure.

FIG. 19 illustrates one explanatory contour map made from example shallow-depth temperature survey data failing to indicate of a geothermal heat resource in accordance with one or more embodiments of the disclosure.

FIG. 20 illustrates another explanatory contour map made from example shallow depth temperature survey data that shows heat flow indicative of a geothermal heat resource in accordance with one or more embodiments of the disclosure.

FIG. 21 illustrates an explanatory geological model estimating geothermal heat flow based upon subsurface data in accordance with one or more embodiments of the disclosure.

FIG. 22 illustrates another explanatory method in accordance with one or more embodiments of the disclosure.

FIG. 23 illustrates various embodiments of the disclosure.

FIG. 24 illustrates one or more method steps in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to defining a plurality of measurement sites along a geographic area of interest, deploying, at each measurement site, at least one electronic sensor group comprising a plurality of vertical profile temperature probes each comprising a stacked plurality of fiber optic sensors, a strain sensor, and a natural advection sensor, recording, using the stacked plurality of fiber optic sensors, a vertical distribution of time-series of temperature measurements, and correcting the vertical distribution of time-series of temperature measurements for strain measured by the strain sensor, natural advection measured by the natural advection sensor, and conductive heating from a surface of the geographic area of interest to obtain a corrected temperature gradient. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when utilizing specialized electronic components such as a vertical temperature profile sensor comprising a device housing, a fiber Bragg grating comprising a plurality of optical fiber sensors and carried by the device housing, a fiber Bragg grating interrogator electrically coupled to the optical fiber sensors, and a data logger operatively coupled to the fiber Bragg grating interrogator, to facilitate shallow temperature measurements in search of geothermal energy sources. These methods not only provide a cost-effective and rapid approach for subsurface evaluation but also allow larger areas to be assessed with a denser sampling grid by utilizing surveys that gather temperature data from relatively shallow depths. Advantageously, embodiments of the disclosure provide an improved method capable of discerning the geothermal thermal signal from the variable influence of surface heating. These enhanced approaches effectively isolate the geothermal component promise to provide more reliable shallow temperature profiles, thereby addressing the limitations present in existing measurement techniques. These advancements would support more efficient resource assessments and contribute to broader, cost-effective geothermal exploration strategies.

One important aspect associated with embodiments of the disclosure is that they are measuring temperature ((T), from the vertical profile) and the temperature gradient (grad(T), calculated from the profile) to explore for geothermal resources. This is new in that previous art made point temperature measurements at shallow depth (on land) or drilled deep holes and measured vertical profiles to calculate a gradient.

By contrast, embodiments of the disclosure utilize both vertical profile temperature measurements collected at shallow depth (four to fifteen meters) and corrected for surface heating and other effects in combination with the gradient calculated from these measurements and other existing (deeper) temperature measurements to explore for geothermal resources.

It will be appreciated that embodiments of the disclosure described herein may be comprised of one or more conventional processors and unique stored program instructions that control the one or more processors to implement, in conjunction with certain non-processor circuits, some, most, or all of the functions of querying optical fiber sensors of a fiber Bragg grating carried by a device housing of a vertical profile temperature probe to obtain vertical profiles of temperature measurements, adjust the vertical profiles of temperature measurements for strain measured by the strain sensor and natural advection measured by the natural advection sensor to determine a heat flow quantity resulting from a geothermal heat resource, and determine whether the resulting heat flow quantities indicate the presence of a geothermal heat resource as described herein. The non-processor circuits may include, but are not limited to, a communication channel, a data reader and/or transmitter, signal drivers, clock circuits, power source circuits, and user input devices.

As such, these functions may be interpreted as steps of a method to perform using one or more processors are configured to adjust vertical profiles of temperature measurements for strain measured by the strain sensor and natural advection measured by the natural advection sensor to determine a heat flow quantity resulting from a geothermal heat resource. In one or more embodiments, the one or more processors are further configured to adjust the vertical profiles of temperature measurements as a function of solar heating of a surface of the geographic area of interest. In some embodiments, the one or more processors are further configured to generate a heat flow map indicating a likelihood of existence of the geothermal energy sources for the geographic area of interest from the heat flow quantity.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (1) while discussing figure A would refer to an element, 1, shown in figure other than figure A.

As noted above, the exploration and quantification of geothermal heat flux are significant for evaluating subsurface energy potential and identifying viable geothermal resources. Traditionally, these evaluations rely on deep borehole surveys, often hundreds of meters below the surface, to measure temperature gradients and calculate heat flow. While effective, these methods are prohibitively expensive, logistically challenging, and environmentally intrusive, limiting their frequency and spatial coverage.

Embodiments of the disclosure contemplate that shallow temperature surveys, e.g., those where temperature measurements are made less than one hundred meters and often less than twenty-five, with one example being between four and ten meters, offer a cost-effective alternative. At the same time, embodiments of the disclosure contemplate that these shallow measurements can be affected by interference from surface temperature fluctuations caused by diurnal and seasonal climatic variations. The resulting low signal-to-noise ratio that might be obtained in the absence of the advantages offered by embodiments of the disclosure complicates the process of isolating the geothermal heat signal from the dominant climate-driven surface heating effects.

Advantageously, embodiments of the disclosure address these limitations by introducing a novel approach for quantifying geothermal heat flux using vertical temperature profiles measured at shallow depths, typically between four and fifteen meters. In one or more embodiments, this approach leverages advanced fiber optic sensing technology, including fiber Bragg grating (FBG) sensors, to achieve high-resolution temperature measurements with millikelvin precision.

In one or more embodiments, these sensors are integrated into a vertical profile temperature probe, which can be deployed into the subsurface using direct-push technology or similar methods. In one or more embodiments, the system also incorporates strain sensors to correct for strain-induced measurement errors. In one or more embodiments, the system further includes advective heat sensors to account for heat transport by fluid movement. By recording time-series temperature data at closely spaced intervals along the probe, the methodology advantageously captures a detailed vertical temperature distribution that is the result of thermal sources contained within the earth, rather than one affected by surface heating, strain, and naturally occurring advection.

In one or more embodiments, to address interference from surface heating, the system utilizes a specialized modeling methodology to distinguish the geothermal heat signal from the climate signal. In one or more embodiments, long-term surface temperature records sourced from weather stations or historical climate data are employed to model the downward propagation of surface heating effects.

In one or more embodiments, a digital filter is subsequently applied to separate the climate signal from the measured temperature profiles. Furthermore, in some embodiments the system incorporates advective heat transport analysis by examining asymmetries in temperature disturbances caused by a controlled heat pulse emitted from the advective heat sensor. The adjusted temperature profiles are then utilized to calculate geothermal heat flux, which can be mapped across the survey area to locate potential geothermal energy resources.

Advantageously, embodiments of the disclosure significantly enhance conventional methods by enabling reliable geothermal heat flux quantification at shallow depths, reducing costs, and increasing spatial sampling density. The described system facilitates rapid, large-scale geothermal exploration while maintaining high measurement accuracy, thereby addressing the limitations of both deep borehole surveys and shallow temperature probes. Furthermore, the integration of advanced sensing technologies and computational modeling ensures adaptability to various geological and climatic conditions, providing a flexible tool for geothermal resource assessment.

In one or more embodiments, a method for exploring terrestrial landmasses to identify subsurface geothermal heat resources using vertical profile temperature probes while accounting for climate-driven surface heating effects begins by selecting measurement sites arranged in a gridded array or similar pattern based on geological information, thereby ensuring optimal spatial sampling. In one or more embodiments, at each site, vertical profiles of transient temperature are measured using closely spaced temperature sensing points along the probe, which is deployed to a depth of at least four meters.

In one or more embodiments, the time-series temperature data collected during disequilibrium conditions, caused by the probe's deployment, can optionally be analyzed to infer subsurface thermophysical properties. Thereafter, equilibrium temperature data are used to calculate a vertical temperature distribution with associated uncertainty.

In one or more embodiments, the method further involves modeling the contribution of the climate signal to the equilibrium temperature profile using long-term surface temperature records and mathematical models, while accounting for fluid advection effects through specialized sensors. By filtering out the climate signal and advection effects, the residual temperature profile is used to calculate the geothermal heat flux, which serves as a direct indicator of geothermal resources. The calculated heat flow values can optionally then be mapped to produce heat flow contour maps and a calibrated geological model, enabling the identification of commercial-grade geothermal heat resources and the estimation of geothermal heat in place at greater depths.

Advantageously, this arrangement enables the accurate measurement of geothermal heat flux at shallow depths, which traditionally suffers from interference caused by surface temperature fluctuations. By incorporating strain sensors and natural advection sensors, the method compensates for distortions in temperature readings caused by mechanical strain and fluid movement, ensuring the integrity of the recorded data. Additionally, correcting for conductive heating from the surface eliminates the masking effects of climate-driven temperature variations, allowing the geothermal signal to be isolated from the climate signal.

The deployment of vertical profile temperature probes with stacked temperature sensors advantageously ensures high spatial resolution of temperature measurements along the depth profile, enabling the detection of subtle geothermal gradients that would otherwise be obscured. This approach reduces the need for deep borehole surveys, which are costly, logistically challenging, and environmentally intrusive, while maintaining measurement accuracy.

The corrected temperature gradients obtained from this method can be used to generate heat flow maps, providing a visual representation of geothermal energy resources across a geographic area. These maps facilitate the identification of commercial-grade geothermal heat resources, supporting efficient resource exploration and reducing the risk of blind drilling. By enabling reliable geothermal heat flux quantification at shallow depths, the method enhances spatial sampling density, reduces costs, and accelerates geothermal exploration efforts.

In one or more embodiments, a system uses a vertical profile temperature probe. In one or more embodiments, this apparatus includes a housing designed to accommodate a fiber Bragg grating (FBG) that incorporates multiple optical fiber sensors arranged in a vertically stacked configuration.

In one or more embodiments, the FBG is electrically connected to a fiber Bragg grating interrogator, which is functionally linked to a data logger for recording temperature measurements. The fiber Bragg grating interrogator interacts with the optical fiber sensors to ascertain a vertical temperature distribution along the length of the housing. The data logger stores the temperature measurements on a non-transient, computer-readable medium, allowing for subsequent analysis.

In one or more embodiments, the housing is engineered to safeguard the optical fiber sensors and associated electronics while enabling deployment into the subsurface. In one embodiment, the housing is fabricated from durable materials such as aluminum or composite polymers to maintain structural integrity during deployment. The apparatus is capable of recording high-resolution temperature profiles at discrete intervals along its length, providing valuable data for assessing geothermal heat flux.

Advantageously, this arrangement of the fiber Bragg grating within the device housing enables precise temperature measurements at multiple discrete points along the vertical profile of the subsurface. By leveraging the optical properties of the FBG, combined with post processing noise correction, the overall system achieves high-resolution temperature sensing with minimal interference from environmental factors such as electromagnetic noise, which is common in conventional electronic sensors. This configuration ensures reliable data acquisition even in challenging subsurface conditions.

The coupling of the fiber Bragg grating interrogator to the optical fiber sensors allows for real-time querying and conversion of optical signals into temperature data. This eliminates the need for manual calibration at each sensing point, streamlining the measurement process and reducing operational complexity. The interrogator's ability to process multiple signals simultaneously enhances the efficiency of data collection, particularly in applications requiring dense spatial sampling.

The integration of the data logger with the interrogator ensures that temperature measurements are stored securely and can be retrieved for subsequent analysis. The use of a non-transient, computer-readable medium provides long-term data retention, which is necessary for geothermal exploration projects that involve extended monitoring periods. This arrangement also facilitates the transfer of data to external systems for advanced modeling and analysis.

The device housing is designed to protect the optical fiber sensors and associated electronics from mechanical strain and environmental contaminants during deployment into the subsurface. This robust construction ensures the durability and reliability of the device, even in harsh geological conditions. Moreover, any actually occurring strain can be compensated for using a companion electronic device in the form of a strain sensor. Additionally, the housing's compatibility with deployment methods such as direct-push technology or hydraulic drilling allows for efficient placement of the device at the desired depth, minimizing disturbance to the surrounding subsurface.

Overall, the vertical profile temperature probe provides a practical and efficient solution for obtaining high-resolution vertical temperature profiles in geothermal exploration. The design of the device addresses the limitations of traditional temperature measurement systems, offering improved accuracy, durability, and data management capabilities.

In one or more embodiments, a system for evaluating geothermal heat flux from geothermal energy sources at a geographic area of interest comprises a plurality of vertical profile temperature probes, each incorporating a vertically oriented fiber Bragg grating (FBG) sensor array, a strain sensor, and a natural advection sensor. In one or more embodiments, the system further includes one or more processors operatively coupled to the temperature probes, strain sensors, and advection sensors.

In one or more embodiments, the processors are configured to adjust vertical profiles of temperature measurements for strain-induced errors detected by the strain sensor and for heat transport effects caused by natural advection, as measured by the advection sensor. These adjustments ensure the accuracy of the temperature data by isolating the geothermal heat signal from external influences such as mechanical strain and fluid movement.

Additionally, in one or more embodiments the processors are capable of compensating for solar heating effects on the surface of the geographic area of interest, thereby refining the temperature profiles to accurately reflect subsurface geothermal heat flux. The corrected temperature profiles are utilized to calculate heat flow quantities, which can be further processed to generate heat flow maps indicating the likelihood of geothermal energy sources within the surveyed area.

Advantageously, the arrangement of vertical profile temperature probes, strain sensors, and natural advection sensors ensures that temperature measurements are corrected for external influences such as mechanical strain and fluid movement, which can distort the geothermal heat signal. By integrating these sensors into the system, the accuracy of the temperature data is significantly improved, allowing for reliable quantification of geothermal heat flux at shallow depths. This eliminates the need for deep borehole surveys, which are costly and logistically challenging.

The inclusion of processors capable of adjusting temperature profiles for strain and advection effects enables real-time data processing and correction. This computational capability ensures that the geothermal heat signal is isolated from external noise, such as surface heating and fluid movement, providing a more precise representation of subsurface heat flow. The corrected data can then be used to generate heat flow maps, which visually represent the likelihood of geothermal energy sources within the surveyed area. These maps facilitate efficient resource exploration and reduce the risk of blind drilling.

The system's capacity to account for strain and advection effects also makes the design adaptable to various geological and climatic conditions, enhancing the functionality in diverse environments. For example, in areas with significant groundwater movement, the natural advection sensor can detect and quantify the impact of fluid transport on heat flow measurements, ensuring that the geothermal signal remains undistorted.

Overall, the system provides a cost-effective and scalable solution for geothermal exploration, enabling high spatial sampling density and accurate heat flow quantification at shallow depths. This approach supports broader exploration strategies and contributes to the efficient identification of commercial-grade geothermal resources. Other advantages will be described below. Still others will be obvious to those of ordinary skill in the art having the benefit of this disclosure.

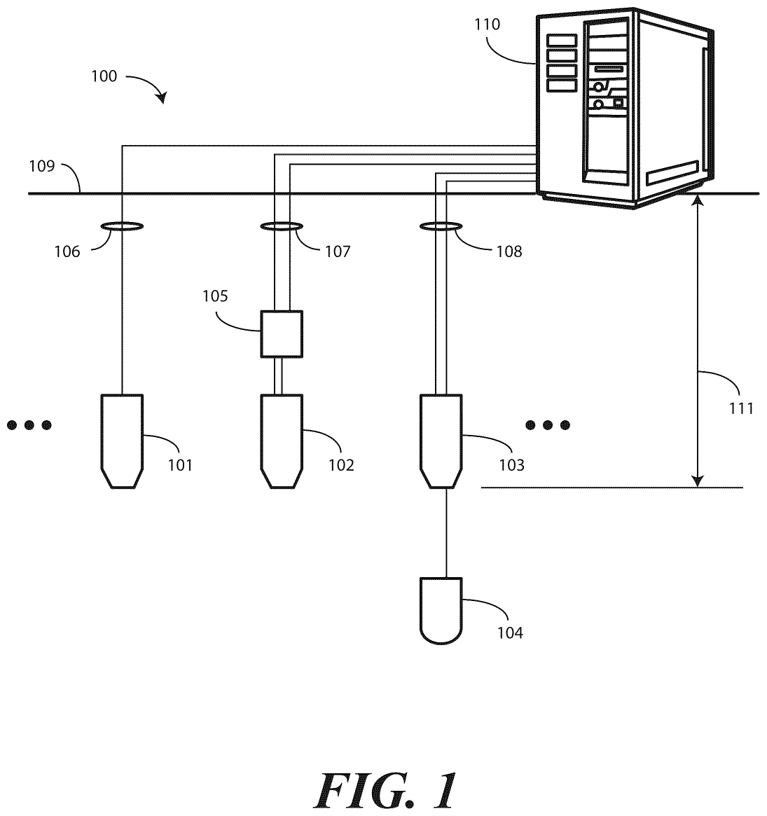

Turning now to FIG. 1, illustrated therein is a system 100 configured for evaluating geothermal heat flux from geothermal energy sources within a geographic area of interest 109. In this illustrative embodiment, the system 100 is designed to quantify subsurface heat flow by leveraging advanced sensing technologies in conjunction with computational analysis.

Accordingly, in one or more embodiments the system 100 comprises a plurality of vertical profile temperature probes 101, 102, 103. In FIG. 1, the system 100 is illustrated with three vertical profile temperature probes 101, 102, 103, but it is to be understood that other embodiments may include more or fewer vertical profile temperature probes depending on the specific requirements of the geographic area of interest and the desired spatial sampling density. Illustrating by example, in an illustrative embodiment, the preferred minimum number of vertical profile measurement locations is six to ten, but with a required minimum of three, with the temperature readings collected from four to fifteen meters in depth.

Illustrating by example, methods for using the system 100 can comprise defining a plurality of measurement sites along the geographic area of interest, and at each measurement site, deploying at least one electronic sensor group. Each electronic sensor group can include a plurality of vertical profile temperature probes, each comprising a stacked plurality of temperature sensors, a strain sensor, and a natural advection sensor.

In an illustrative embodiment, each measurement site may include nine vertical profile temperature probes, one strain sensor, and one natural advection sensor to ensure comprehensive data collection and correction for external influences such as strain and fluid movement. However, other embodiments may include different quantities of these components, such as fewer vertical profile temperature probes for smaller survey areas or additional probes and sensors for larger or more complex survey areas, thereby providing flexibility to adapt the system to various geological and operational conditions.

Thus, in addition to the illustrative embodiment of FIG. 1, the system 100 can be adapted to various use cases by modifying the quantities and configurations of the vertical profile temperature probes, strain sensors, and natural advection sensors to suit specific survey requirements. Illustrating by example, for localized geothermal exploration in areas with limited spatial extent, such as a single geothermal well site, the system may include only three vertical profile temperature probes deployed at strategic locations around the well. A single strain sensor and natural advection sensor may be sufficient to correct for external influences, ensuring accurate heat flux measurements without the need for extensive equipment.

For larger geographic areas, such as a geothermal field spanning several square kilometers, the system may include fifty to one hundred vertical profile temperature probes arranged in a grid pattern. These probes may be spaced generously from each other, such as on the order of one hundred meters. Of course, a smaller number of probes can be used and reused across the geothermal field to reduce cost. Each grid cell may include one strain sensor and one natural advection sensor to account for localized variations in strain and fluid movement. This configuration allows for high spatial resolution while maintaining cost-effectiveness.

In areas with complex geological features, such as fault zones or areas with suspected blind geothermal systems, the system may include a denser array of vertical profile temperature probes, with spacing reduced to a smaller number of meters between probes. Each measurement site may include up to twenty vertical profile temperature probes, two strain sensors, and two natural advection sensors to ensure comprehensive data collection and correction for localized anomalies.

In remote or inaccessible regions, such as mountainous terrain or offshore geothermal sites, the system may include fewer vertical profile temperature probes deployed at key locations identified through remote sensing or preliminary geological surveys. Portable strain sensors and natural advection sensors may be used to minimize logistical challenges while maintaining data accuracy.

For ongoing monitoring of geothermal power plants, the system may include a fixed array of vertical profile temperature probes installed permanently at critical locations around the plant. Each site may include three to five probes, along with strain sensors and natural advection sensors, to provide continuous data on subsurface heat flux and ensure the long-term stability and efficiency of the geothermal resource.

These use cases demonstrate the flexibility of the system 100 in adapting to different survey scales, geological conditions, and operational requirements, making it a versatile tool for geothermal exploration and resource assessment. Other configurations for the system 100 will be obvious to those of ordinary skill in the art having the benefit of this disclosure.

In one or more embodiments, the vertical profile temperature probes 101, 102, 103 of FIG. 1 include a stacked plurality of temperature sensors arranged along their vertical length to enable high-resolution temperature measurements at discrete intervals. In an illustrative embodiment, these sensors are optical sensors defining a fiber Bragg grating (FBG), which offers advantages such as high precision, millikelvin resolution, and immunity to electromagnetic interference.

However, alternate temperature sensing technologies can also be employed depending on the specific application requirements. For example, thermistors provide a cost-effective solution with high sensitivity to temperature changes, making them suitable for applications requiring rapid response times.

Resistance temperature detectors (RTDs) offer excellent accuracy and stability over a wide temperature range, making them ideal for long-term monitoring. Thermocouples, known for their durability and ability to measure high-temperature ranges, can be used in harsh environments where other sensors may fail. Additionally, infrared temperature sensors can be utilized for non-contact temperature measurements, which may be advantageous in scenarios where direct physical coupling to the subsurface is challenging.

In still other embodiments, distributed temperature sensing (DTS) fiber optics or coiled DTS fiber optics could be substituted for the fiber Bragg grating. DTS using fiber optics is a technology that enables temperature measurement along the full length of a fiber optic cable, rather than at discrete points. This process is accomplished by analyzing the interaction of light with the fiber optic material. The following paragraphs provide a simplified explanation of the operational mechanism.

As is known in the art, fiber optic cables are thin strands of glass or plastic that transmit light. When light travels through the fibers, the light engages with the material in particular ways. These engagements can vary based on the temperature of the fiber.

In DTS, a laser or light source sends pulses of light into the fiber optic cable. As the light travels through the cable, a portion of the light is scattered back toward the source. This scattering is referred to as Raman scattering. Raman scattering occurs in two forms: Stokes scattering where light is scattered at a lower energy level and Anti-Stokes scattering where light is scattered at a higher energy level. The ratio of these two types of scattered light changes with temperature. By measuring this ratio, the system can determine the temperature at different points along the fiber.

Accordingly, the fiber optic cable acts like a long thermometer. When used, the system can analyze the scattered light to calculate the temperature at various locations along the cable. This allows for continuous temperature monitoring over long distances, sometimes up to tens of kilometers.

Coiled fiber optics represent a variation of distributed temperature sensing (DTS) technology, wherein the fiber optic cable is arranged in coils or loops within a designated area to improve temperature measurement capabilities in that specific region. Coiling the fiber optic cable increases the density of the sensing area. This means the system can focus on measuring temperature in a smaller, localized region with higher precision.

When the fiber is coiled, the light pulses interact more frequently with the material in the coiled region. This amplifies the temperature signal, facilitating the detection of small changes in temperature.

Coiled fiber optics are often used in areas where detailed temperature monitoring is needed, such as geothermal exploration or industrial processes. For example, in geothermal applications, coiled fiber optics can be placed in boreholes to measure temperature gradients with high accuracy.

Distributed temperature sensing fiber optics are beneficial alternatives for multiple reasons. Unlike traditional thermometers, which measure temperature at specific points, DTS provides a full temperature profile along the cable. Additionally, they can monitor temperature over kilometers, making them ideal for applications like pipelines, power cables, and geothermal exploration. Moreover, fiber optics are durable and can endure high temperatures, significant pressure, and exposure to chemicals.

In summary, DTS fiber optics use light to measure temperature along the length of a cable, while coiled DTS fiber optics focus on specific areas for more detailed measurements. This technology is a powerful tool for monitoring temperature in a wide range of applications. These alternate sensing technologies provide flexibility in adapting the vertical profile temperature probes to diverse geological and operational conditions.

In one or more embodiments, each probe incorporates a vertically oriented fiber Bragg grating, and these probes are positioned within boreholes 106, 107, 108. As illustrated, each borehole 106, 107, 108 is drilled into the geographic area of interest 109 to a depth 111 ranging between four and fifteen meters. As a result, the vertical profile temperature probes 101, 102, 103 are configured to record high-resolution temperature measurements at discrete intervals along their vertical length, enabling the capture of detailed vertical temperature distributions.

Moreover, in one or more embodiments the system 100 further includes a strain sensor 105 and a natural advection sensor 104. In some embodiments, the strain sensor 105 is operatively coupled to the vertical profile temperature probe 102 for the purpose of measuring strain-induced errors that may affect the accuracy of temperature readings. In comparison, the natural advection sensor 104 is deployed to detect and quantify heat transport effects resulting from fluid movement within the subsurface as a result of climate heating upon the surface. These sensors are arranged to account for external influences such as mechanical strain and fluid advection, thereby isolating the geothermal heat signal from other interference sources.

Turning next to the processing aspects, the system 100 is operatively connected to one or more processors situated within a measurement control and data analysis center 110. In one or more embodiments, these processors are configured to adjust the vertical profiles of temperature measurements based on strain measured by the strain sensor 105 and natural advection measured by the natural advection sensor 104. Additionally, the processors can compensate for solar heating effects present on the surface of the geographic area of interest 109, thereby further refining the temperature profiles to accurately reflect the subsurface geothermal heat flux.

Accordingly, the corrected temperature profiles are utilized by the processors to calculate heat flow quantities. In one or more embodiments, these calculated quantities are processed to generate heat flow maps that visually represent the likelihood of geothermal energy sources within the surveyed area, thereby offering meaningful perspectives on the spatial distribution of geothermal resources and improving the effectiveness of exploration efforts while minimizing the risk of blind drilling.

The arrangement of the vertical profile temperature probes 101, 102, 103, together with the strain sensor 105 and the natural advection sensor 104, ensures high spatial resolution and accuracy in temperature measurements. As such, this configuration allows the system 100 to reliably quantify geothermal heat flux at shallow depths, effectively addressing the limitations of traditional deep borehole surveys while maintaining cost-effectiveness and operational efficiency.

To illustrate by example, the Great Basin region of the United States could represent a notable geographic area of interest 109 for the application of the disclosed technology, particularly due to its significant geothermal potential and prevalence of blind geothermal systems. Blind geothermal systems, which lack surface expressions such as hot springs or fumaroles, pose significant challenges for exploration, as traditional methods relying on surface indicators are ineffective.

In this region, the disclosed technology can be applied to deploy an array of vertical profile temperature probes 101, 102, 103 in a grid pattern across suspected geothermal zones, such as areas near brecciated fault zones or regions with inferred subsurface hydrothermal activity. For example, a silica sinter deposit at the surface may suggest geothermal fluid flow along a fault, but in the absence of such evidence, the disclosed technology facilitates the detection of discrete outflow zones by measuring vertical temperature distributions at shallow depths. These measurements, corrected for climate-driven surface heating and advection effects, can yield high-resolution heat flow maps that delineate the thermal signature of blind geothermal resources.

Such heat flow maps not only identify the presence of geothermal resources but also provide valuable insights into subsurface fault geometry and hydrothermal system dynamics. This information can guide the optimal placement of confirmation temperature gradient holes (TGHs) or exploratory wells (shown as boreholes 106, 107, 108 in FIG. 1), ensuring that drilling targets the footwall of the fault where geothermal heat is most concentrated.

Furthermore, the disclosed methods and systems are capable of producing detailed contour maps of heat flow at shallow depths, which reduces the risk of blind drilling and enhances the efficiency of geothermal exploration efforts. By enabling reliable resource identification and characterization in regions like the Great Basin, the described methods and systems contribute to advancements in geothermal exploration while minimizing environmental and financial costs.

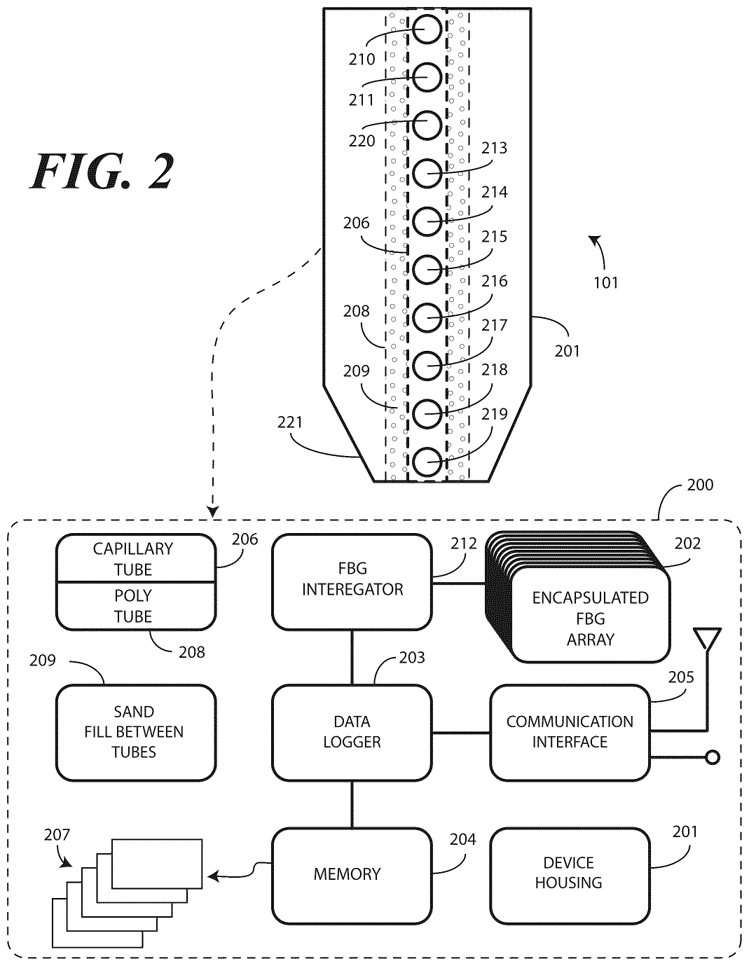

Turning now to FIG. 2, illustrated therein is one explanatory vertical profile temperature probe 101 configured in accordance with one or more embodiments of the disclosure. More specifically, FIG. 2 illustrates a detailed schematic of the vertical profile temperature probe 101 configured for measuring vertical temperature distributions in shallow subsurface environments. In this embodiment, the vertical profile temperature probe 101 is designed to provide high-resolution temperature measurements with millikelvin precision, thereby enabling the quantification of geothermal heat flux at shallow depths. Accordingly, the components of the vertical profile temperature probe 101 and their respective functionalities are described below.

In one or more embodiments, the vertical profile temperature probe 101 comprises a device housing 201 designed to accommodate a fiber Bragg grating (FBG) array 202 that incorporates a plurality of optical fiber sensors 210,211,220,213,214,215,216,217,218,219 arranged in a vertically stacked configuration. In one or more embodiments, the device housing 201, which may be between one and five meters in length, terminates at a frustoconical head 221 to facilitate insertion into the subsurface.

In one or more embodiments, the optical fiber sensors 210,211,220,213,214,215,216,217, 218,219 are positioned along the device housing at predetermined intervals, such as five to twenty-five centimeters, to generate temperature measurements at discrete points along the length of the device housing. These measurements are recorded as a time-series temperature record by a data logger 203 operatively coupled to a FBG interrogator 212, which queries the optical fiber sensors 210,211,220,213,214,215,216,217,218,219 to determine a vertical temperature distribution 207.

The recorded data is stored on a non-transient, computer-readable medium represented by memory 204, thereby enabling subsequent analysis to determine geothermal heat flux. In one or more embodiments, the vertical profile temperature probe 101 is deployed at depths between four and fifteen meters below a site of interest, where the device collects high-resolution temperature data suitable for quantifying subsurface geothermal heat flow.

In one embodiment, the encapsulated fiber Bragg grating (FBG) array 202 serves as the primary sensing component of the vertical profile temperature probe 101. As illustrated, the FBG array 202 includes a series of optical fiber sensors 210, 211, 220, 213, 214, 215, 216, 217, 218, and 219 arranged in a vertically stacked configuration within a capillary tube 206. During operation, each optical fiber sensor 210,211,220,213,214,215,216,217,218,219 measures temperature at discrete intervals along the vertical length of the probe, thereby enabling the generation of a detailed vertical temperature distribution 207. It is worth noting that the encapsulation of the FBG array 202 provides effective protection against environmental contaminants and mechanical strain during subsurface deployment.

Subsequently, the capillary tube 206 is shown to house the encapsulated FBG array 202 while providing structural support. Surrounding the capillary tube 206, a sand column 209, positioned between the capillary tube 206 and a polycarbonate tube 208, serves multiple functions. For example, the sand column 209 facilitates thermal insulation and mechanical stabilization, as well as ensuring proper coupling between the temperature sensors and the surrounding geological formation. In this regard, the polycarbonate tube 208 offers an additional protective barrier and enhances the overall structural integrity of the probe.

Furthermore, the FBG interrogator 212 is operatively coupled to the encapsulated FBG array 202. In this configuration, the FBG interrogator 212 queries the optical fiber sensors 210-219 to obtain temperature measurements by converting the optical signals reflected by the FBG sensors into temperature data, thereby defining the vertical temperature distribution 207. The high temporal sampling frequency of the FBG interrogator 212 enables precise and rapid data acquisition, making the system appropriate for applications that involve dense spatial sampling.

In addition, the data logger 203 is connected to the FBG interrogator 212 and is responsible for recording the temperature data obtained from the optical fiber sensors. Accordingly, the recorded data is stored in a non-transient, computer-readable medium represented by memory 204, which facilitates long-term retention of temperature measurements, supporting extended monitoring periods and subsequent analysis.

Turning next to the communication interface 205, this component facilitates the transfer of the recorded temperature data from the vertical profile temperature probe 101 to external systems, such as the measurement control and data analysis center (110). In one embodiment, the communication interface 205 may be implemented as either a wired or wireless connection, depending on the deployment requirements. Thus, this interface enables real-time data transmission and remote monitoring capabilities.

Moreover, in one or more embodiments the device housing 201 encloses all the aforementioned components, including the encapsulated FBG array 202, capillary tube 206, polycarbonate tube 208, sand column 209, FBG interrogator 212, data logger 203, memory 204, and communication interface 205. In this manner, the housing is designed to withstand harsh geological conditions and mechanical strain during deployment. For example, the housing is fabricated from durable materials, such as aluminum or composite polymers, to ensure both reliability and longevity.

It should be noted that alternate embodiments of the vertical profile temperature probe 101 will be obvious to those of ordinary skill in the art having the benefit of this disclosure. In these embodiments, additional sensing technologies, such as thermistors, resistance temperature detectors (RTDs), or thermocouples, may be incorporated, depending on specific application requirements. For instance, thermistors could be used for cost-effective, high sensitivity temperature sensing; RTDs could offer notable accuracy and stability over a wide temperature range; and thermocouples may be employed in environments characterized by high or low temperatures or where enhanced durability is desired.

Accordingly, the sand column 209 may be replaced with other insulating materials, such as silica gel or foam, to enhance thermal insulation and mechanical stability. Similarly, the polycarbonate tube 208 could alternatively be substituted with other robust materials, such as stainless steel or reinforced polymers, thereby adapting the probe for use under varied geological conditions.

In other embodiments, the communication interface 205 may be enhanced with advanced wireless technologies, such as Bluetooth or satellite communication, to facilitate data transmission from remote or otherwise inaccessible regions. Additionally, the memory 204 could be upgraded to incorporate cloud-based storage solutions, thereby enabling real-time data access and analysis.

In some embodiments, specific use cases for the vertical profile temperature probe 101 are detailed as follows. For geothermal exploration, the probe can be deployed in a grid pattern across a suspected geothermal field to measure vertical temperature distributions at shallow depths. Here, the recorded temperature data, corrected for climate-driven surface heating and advection effects, can be employed to generate heat flow maps that identify potential geothermal energy resources.

In another embodiment, the probe can be used for environmental monitoring of subsurface temperature variations in areas affected by climate change or human activities. The high-resolution temperature data provides insight into the thermal dynamics of the subsurface and aids in assessing the impact of external factors. Similarly, in geotechnical applications, the probe is operable to measure subsurface temperature profiles at construction sites or mining areas, thereby offering data that evaluates the thermal properties of the geological formation and supports the improvement of engineering designs.

Additionally, with respect to hydrothermal system analysis, the probe may be employed to detect temperature anomalies associated with fluid movement in regions characterized by active hydrothermal systems. The acquired data can support the understanding of the dynamics of the hydrothermal system and inform resource management strategies. For long-term monitoring applications, the probe may be permanently installed in strategically important locations—such as geothermal power plants or fault zones—to provide ongoing data on subsurface temperature variations, thereby contributing to the stability and operational effectiveness of geothermal resources or aiding in seismic activity monitoring.

Thus, by integrating advanced sensing technologies and robust design features, the vertical profile temperature probe 101 offers a versatile and cost-effective solution for subsurface temperature measurement in a diverse array of applications.

To recap, in FIG. 2 is depicted a schematic representation of the vertical profile temperature probe 101 configured for measuring vertical temperature distributions in shallow subsurface environments. In this embodiment, the vertical profile temperature probe 101 is designed to provide high-resolution temperature measurements with millikelvin precision, thereby enabling the quantification of geothermal heat flux at shallow depths. Accordingly, the components of the vertical profile temperature probe 101 and their respective functionalities are again summarized below.

In one illustrative embodiment, the vertical profile temperature probe 101 comprises a device housing 201, which accommodates an encapsulated FBG array 202. As shown, the encapsulated FBG array 202 includes a plurality of optical fiber sensors 210,211,220,213,214, 215,216,217,218, 219 arranged in a vertically stacked configuration. When arranged along the device housing 201 at predetermined intervals, such as five to twenty-five centimeters, these optical fiber sensors generate temperature measurements at discrete points along the length of the device. The encapsulation of the FBG array 202 serves to protect against environmental contaminants and mechanical strain during subsurface deployment.

In one or more embodiments, the encapsulated FBG array 202 is housed within a capillary tube 206, which serves to provide structural support. Surrounding the capillary tube 206, a sand column 209 is positioned between the capillary tube 206 and a polycarbonate tube 208. In this configuration, the sand column 209 serves multiple functions, including thermal insulation, mechanical stabilization, and ensuring proper coupling between the temperature sensors and the surrounding geological formation. Moreover, the polycarbonate tube 208 offers an additional protective barrier and enhances the structural integrity of the probe.

In one or more embodiments, the FBG interrogator 212 is operatively coupled to the encapsulated FBG array 202. The FBG interrogator 212 queries the optical fiber sensors 210,211, 220,213,214,215,216,217,218,219 to obtain temperature measurements by converting the optical signals reflected by the FBG sensors into temperature data. The high temporal sampling frequency of the FBG interrogator 212 facilitates precise and rapid data acquisition, which enhances the system's suitability for applications involving dense spatial sampling.

In addition, the data logger 203 is connected to the FBG interrogator 212 and is responsible for recording the temperature data obtained from the optical fiber sensors. Accordingly, the recorded data is stored in a non-transient, computer-readable medium represented by memory 204, thus facilitating long-term retention of temperature measurements to support extended monitoring periods and subsequent analysis.

Moreover, the communication interface 205 facilitates the transfer of the recorded temperature data from the vertical profile temperature probe 101 to external systems, such as the measurement control and data analysis center. In some embodiments, the communication interface 205 may be implemented as either a wired or wireless connection, thereby enabling real-time data transmission and remote monitoring capabilities.

In the illustrated embodiment, the device housing 201 encloses all of the aforementioned components, including the encapsulated FBG array 202, capillary tube 206, polycarbonate tube 208, sand column 209, FBG interrogator 212, data logger 203, memory 204, and communication interface 205. When subjected to harsh geological conditions and mechanical strain during deployment, the housing is designed to withstand such impacts by being fabricated from durable materials, such as aluminum or composite polymers, thereby ensuring both reliability and longevity.

In alternative embodiments, additional sensing technologies may be incorporated into the vertical profile temperature probe 101. For instance, thermistors could be used for cost-effective, high-sensitivity temperature sensing; resistance temperature detectors (RTDs) could offer notable accuracy and stability over a wide temperature range; and thermocouples may be employed in environments characterized by high or low temperatures or where enhanced durability is desired.

Furthermore, in some embodiments, the sand column 209 may be replaced with other insulating materials, such as silica gel or foam, to further enhance thermal insulation and mechanical stability. Similarly, the polycarbonate tube 208 could alternatively be substituted with other robust materials, such as stainless steel or reinforced polymers, thereby adapting the probe for use under varied geological conditions.

Accordingly, in other embodiments, the communication interface 205 may be enhanced with advanced wireless technologies, such as Bluetooth or satellite communication, to facilitate data transmission from remote or otherwise inaccessible regions. In addition, the memory 204 could be upgraded to incorporate cloud-based storage solutions, thereby enabling real-time data access and analysis.

Thus, the vertical profile temperature probe 101 provides a versatile and cost-effective solution for subsurface temperature measurement in a diverse array of applications, including geothermal exploration, environmental monitoring, geotechnical analysis, and hydrothermal system studies. Other advantages offered by the vertical profile temperature probe 101 will be obvious to those of ordinary skill in the art having the benefit of this disclosure.

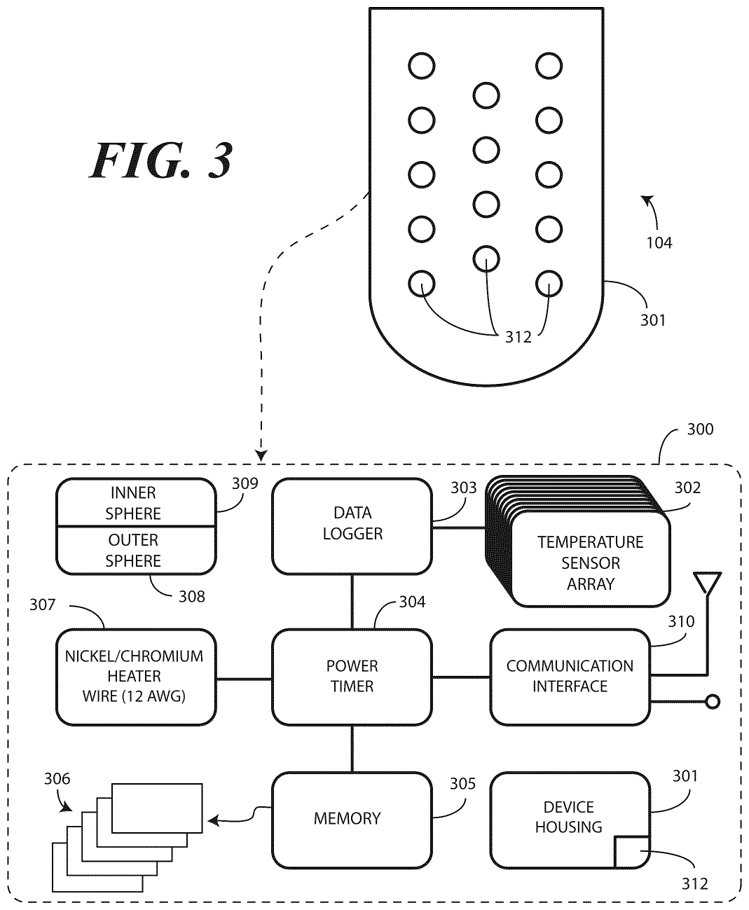

Turning now to FIG. 3, illustrated therein is one explanatory natural advection sensor 104. In one or more embodiments, the natural advection sensor 104 is configured to detect and quantify heat transport effects caused by fluid movement within the subsurface. In this embodiment, the natural advection sensor 104 is designed to measure temperature disturbances resulting from advective heat transport and includes a plurality of components that work in unison to provide accurate and reliable data.

Accordingly, in one or more embodiments the natural advection sensor 104 comprises a device housing 301 that encloses the internal components and provides structural integrity. In this design, the device housing 301 is equipped with a plurality of perforations 312, which permit water and other fluids from the surrounding soil to penetrate the sensor. This feature ensures that the sensor interacts directly with the subsurface environment, thereby enabling the detection of fluid flow and associated heat transport effects.

In one embodiment, within the device housing 301 an inner sphere 309 is concentrically disposed inside an outer sphere 308. Therein, the inner sphere 309 houses a nickel-chromium heater wire 307, which serves as a controlled heat source. When activated, the nickel-chromium heater wire 307 emits a heat pulse of known power, creating a temperature disturbance that subsequently propagates outward through the surrounding subsurface material. Simultaneously, the outer sphere 308 provides additional structural support and facilitates the proper distribution of the heat pulse.

Furthermore, a temperature sensor array 302, comprising a plurality of thermistors, is positioned circumferentially about the inner sphere 309. As such, these thermistors are arranged to record temperature changes at discrete intervals, thereby capturing the temperature field generated by the heat pulse emitted from the nickel-chromium heater wire 307.

Under circumstances where the temperature readings are symmetric, the heat transport is determined to be primarily conductive; however, any asymmetries in the temperature field indicate the presence of advective heat transport induced by fluid movement. Accordingly, the temperature sensor array 302 plays an important role in detecting these asymmetries and quantifying both the magnitude and the direction of the fluid flow.

In another aspect, the data logger 303 is operatively coupled to the temperature sensor array 302 to record the temperature readings obtained from the thermistors. The readings are stored in a memory 305, which constitutes a non-transient, computer-readable medium. Hence, the memory 305 ensures long-term retention of the recorded data 306, thereby facilitating subsequent analysis and modeling.

Moreover, a power timer 304 is connected to the nickel-chromium heater wire 307 to control the timing and duration of the heat pulse. This mechanism ensures that the heat source operates in a controlled, consistent, and repeatable manner. Additionally, the power timer 304 optimizes energy usage, rendering the system efficient for extended field deployments.

In some embodiments, the communication interface 310 facilitates the transfer of the recorded temperature data and other indicia to external systems, such as the measurement control and data analysis center 110. Depending on the deployment requirements, the communication interface 310 can be implemented as either a wired or wireless connection. As a result, this feature enables real-time data transmission and remote monitoring capabilities, thereby enhancing the operational flexibility of the natural advection sensor 104.

In one or more embodiments, the natural advection sensor 104 is positioned at a greater depth within the soil than the vertical profile temperature probes (101, 102, 103) as illustrated in FIG. 1. In this configuration, the sensor is adjusted to detect advective heat transport effects that occur at deeper subsurface levels, thereby enhancing the temperature measurements obtained by the vertical profile temperature probes.

In one or more embodiments, the natural advection sensor 104 is designed to detect and quantify heat transport effects caused by fluid movement within the subsurface. In one or more embodiments, the natural advection sensor 104 features a temperature sensor array 302 configured as concentric array of thermistors spaced at intervals of one to five centimeters around a central heat source, shown illustratively as the nickel-chromium heater wire 307.

In one or more embodiments, the heat source emits a controlled heat pulse of known power, creating a temperature disturbance that propagates outward through the surrounding subsurface material. Temperature readings are recorded at each thermistor location, and any asymmetries in the temperature field are indicative of advective heat transport.

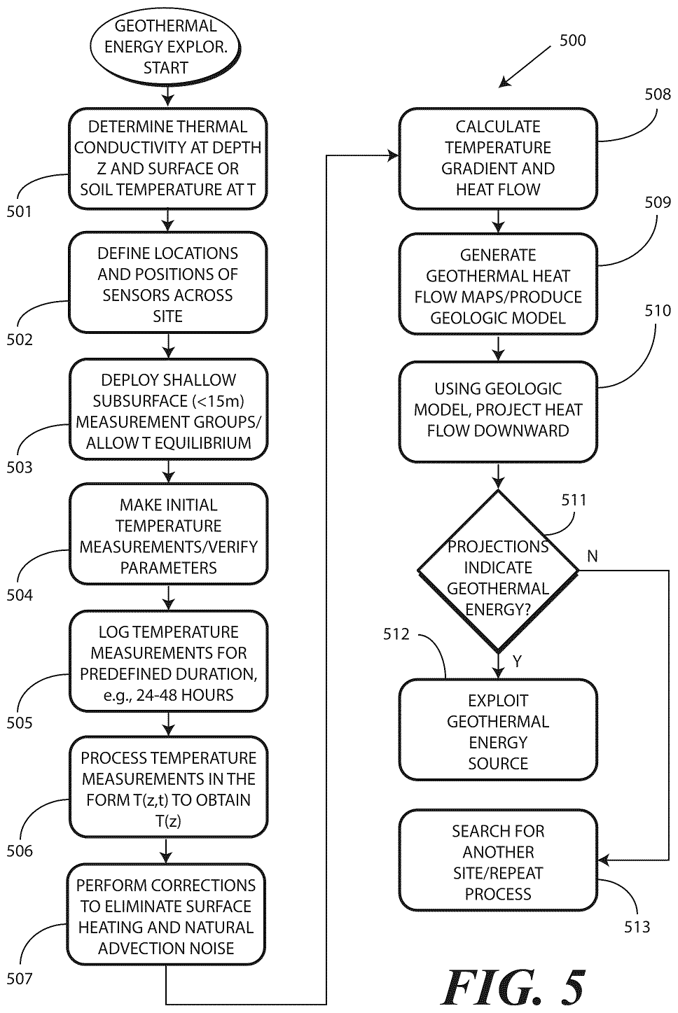

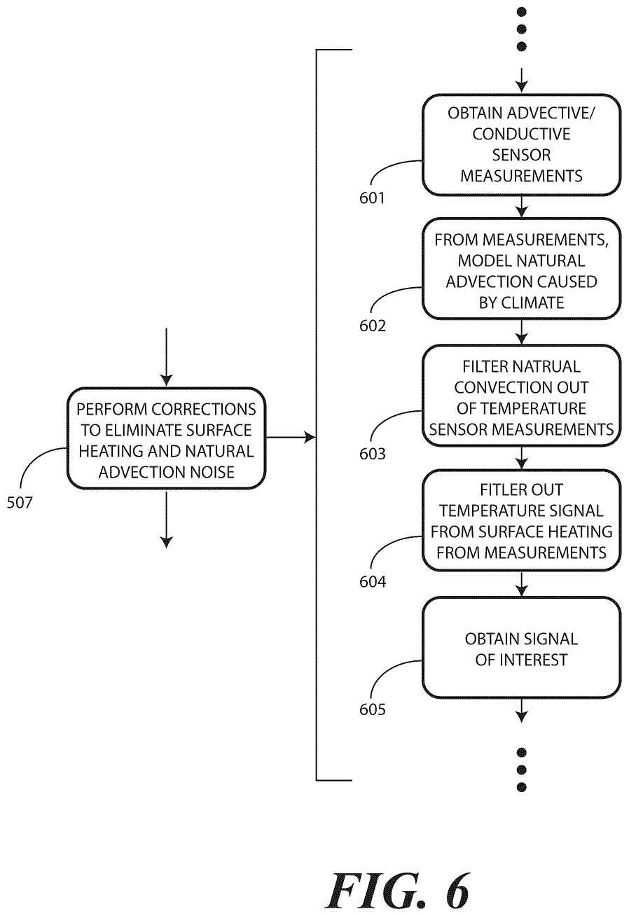

These asymmetries can then be analyzed as described below in FIGS. 5-6 to estimate the magnitude and direction of fluid movement, which can then be incorporated into the numerical model used to correct the vertical temperature profile for advection effects. In one or more embodiments, the device housing 301 of the natural advection sensor 104 defines one or more perforations 312 to allow free fluid flow around the sensing elements, ensuring accurate detection of advective heat transport in diverse geological conditions.

Overall, in this illustrative embodiment, the construction of the natural advection sensor 104 involves durable materials to ensure reliability and longevity under harsh subsurface conditions. For example, the device housing 301 may be fabricated from materials such as aluminum or composite polymers, while the inner sphere 309 and outer sphere 300 may be constructed from thermally stable materials capable of withstanding the heat pulse generated by the nickel-chromium heater wire 307. Thus, by integrating advanced sensing technologies and precise control mechanisms, the sensor provides a robust and efficient solution for detecting and quantifying advective heat transport in geothermal exploration, enhancing the accuracy of subsurface temperature measurements and supporting the identification of geothermal energy resources.

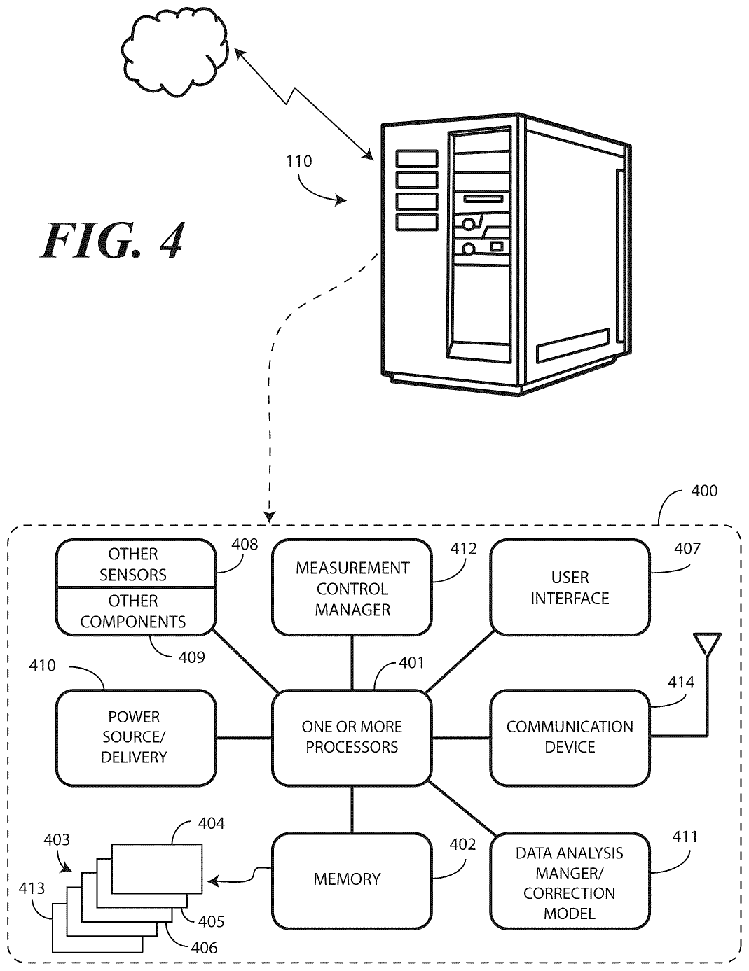

Turning now to FIG. 4, illustrated therein is a system diagram for a measurement control and data analysis center 110 configured to manage and process data collected from geothermal exploration sensors and devices. A schematic block diagram 400 of the measurement control and data analysis center 110 is also shown. In this embodiment, the measurement control and data analysis center 110 integrates multiple components for the acquisition, correction, and analysis of temperature measurements, strain data, and advective heat transport data, thereby enabling the quantification of geothermal heat flux.

In one or more embodiments, the system includes one or more processors 401 that serve as the central processing units for executing instructions and managing system operations. When in operation, these processors 401 are operatively coupled to a memory 402 which stores computer-readable instructions, program modules, and data structures necessary for the system's function. In some embodiments, the memory 402 comprises both volatile and nonvolatile storage media, such as RAM, ROM, flash memory, and other storage technologies, ensuring the retention of data and program instructions during system operation.

In one or more embodiments, a data analysis manager/correction model 411 is employed to process the vertical profiles of temperature measurements collected by the vertical profile temperature probes. In this regard, the data analysis manager/correction model 411 adjusts the temperature profiles for strain-induced errors measured by the strain sensor and for heat transport effects induced by natural advection as measured by the natural advection sensor.

Furthermore, in one or more embodiments this module compensates for climate-driven surface heating effects, thereby isolating the geothermal heat signal from external influences. The corrected data is then utilized to calculate heat flow quantities, which can be further processed to generate heat flow maps indicative of the likelihood of geothermal energy sources within the surveyed area.

In another aspect, the measurement control manager 412 is operable with the plurality of vertical profile temperature probes, the strain sensor, and the natural advection sensor to coordinate the collection of measurement data. By virtue of this coordination, the sensors are properly synchronized, and the data acquisition process is optimized for both accuracy and efficiency.

In addition, a user interface 407 is provided to facilitate interaction between the system and the operator. Typically, the user interface comprises graphical displays, touch-sensitive input devices, or alternative mechanisms for providing real-time feedback and control of the system's operations. Thus, the operator is enabled to monitor sensor status, adjust system parameters, and review preliminary data outputs.

In one or more embodiments, a communication device 414 is included to enable the system to transmit and receive data to and from external systems, such as remote servers or cloud-based platforms. In some embodiments, the communication device 414 supports both wired and wireless communication protocols—including RF, infrared, and network-based connections—to ensure seamless integration with the other components of the geothermal exploration infrastructure.

Moreover, the system is powered by a power source/delivery module 410 which can be operable to supply energy to all components of the measurement control and data analysis center 110. For example, the power source/delivery module 410 may include batteries, power converters, or other energy delivery mechanisms to ensure reliable operation even in remote or challenging environments. In certain embodiments, the power source/delivery module 410 may also provide power to sensors and probes deployed in the field.

Additionally, other sensors 408 and components 409 may be integrated into the system to enhance the functionality of the system. By way of illustration, these additional sensors can include environmental monitoring devices, such as weather stations, or supplementary geophysical instruments, such as seismic sensors. As a result, these components provide auxiliary data that refines the overall analysis and improves the accuracy of geothermal heat flux quantification.

In this illustrative embodiment, the system is designed to operate within a networked environment, thereby enabling integration of data from multiple measurement sites and facilitating the coordination of large-scale geothermal exploration efforts. Due to the modular design of the measurement control and data analysis center 110, the system can be adjusted to accommodate diverse geological and operational conditions, enhancing its utility as a tool for geothermal resource assessment.

In addition to the aforementioned components, in one or more embodiments the one or more processors 401 can comprise, but is not limited to, one or more central processing units (CPUs). A system bus can couple various system components including the memory 402 to the one or more processors 401. The system bus may be any of several types of bus structures including a memory bus or memory controller, a peripheral bus, and a local bus using any of a variety of bus architectures.

The user interface 407 can optionally include graphics hardware, such as for the display of graphical user interfaces, including, but not limited to, a graphics hardware interface and a physical display device. The user interface can, in some embodiments, be capable of receiving touch-based user input, such as a touch-sensitive, or multi-touch capable, display device. Depending on the specific physical implementation, one or more of the one or more processors 401, the memory 402, and other components of the measurement control and data analysis center 110 can be physically co-located, such as on a single chip. In such a case, some or all of the system bus can be nothing more than silicon pathways within a single chip structure.

The memory 402 also typically includes computer readable media, which can include any available media that can be accessed by one or more processors 401 and includes both volatile and nonvolatile media and removable and non-removable media. By way of example, and not limitation, the memory 402 may comprise computer storage media and communication media.

Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the measurement control and data analysis center 110. One or more modules 403 stored in the memory 402 cam comprise computer readable instructions, data structures, program modules or other data that is executable by the one or more processors 401.

A basic input/output system 404 (BIOS), containing the basic routines that help to transfer information between elements within measurement control and data analysis center 110, such as during start-up, is typically stored in ROM. RAM typically contains data and/or program modules that are immediately accessible to and/or presently being operated on by the one or more processors 401. By way of example, and not limitation, FIG. 4 illustrates the operating system 405 along with other program modules 406, and program data 413.

The measurement control and data analysis center 110 may also include other removable/non-removable, volatile/nonvolatile computer storage media. By way of example only, a hard disk drive may read from or write to non-removable, nonvolatile media. Other removable/non-removable, volatile/nonvolatile computer storage media that can be used with the exemplary measurement control and data analysis center 110 include, but are not limited to, magnetic tape cassettes, flash memory cards, digital versatile disks, digital video tape, solid state RAM, solid state ROM, and other computer storage media, as defined and delineated above. The hard disk drive is typically connected to the system bus through a non-removable memory interface.

The drives and their associated computer storage media discussed above and illustrated in FIG. 4, provide storage of computer readable instructions, data structures, program modules and other data for the measurement control and data analysis center 110. In FIG. 4, for example, a hard disk drive may store the operating system 405, other program modules 406, and program data 413.

The measurement control and data analysis center 110 can operate in a networked environment using logical connections to one or more remote computers. The measurement control and data analysis center 110 is illustrated as being connected to a general network using the communication device 414. In a networked environment, program modules depicted relative to the measurement control and data analysis center 110, or portions or peripherals thereof, may be stored in the memory of one or more other computing devices that are communicatively coupled to the measurement control and data analysis center 110 through the network. It will be appreciated that the network connections shown are exemplary and other means of establishing a communications link between computing devices may be used.

Although described as a single physical device, the exemplary measurement control and data analysis center 110 can be a virtual computing device, in which case the functionality of the above-described physical components, such as the one or more processors 401, the memory 402, the communication device 414, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability.

In the situation where the exemplary measurement control and data analysis center 110 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executed within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

The preceding description provides details regarding multiple mechanisms that can be implemented in an interrelated manner or can be implemented independently of one another. Without excluding any of the mechanisms described in detail above, the foregoing enumerations are directed to particular ones of those mechanisms:

A method for quantifying shallow earth geothermal heat flux from subsurface energy sources, the method comprising: defining a plurality of measurement sites along a geographic area of interest; at each measurement site, deploying at least one electronic sensor group comprising: a plurality of vertical profile temperature probes each comprising a stacked plurality of fiber optic sensors; a strain sensor; and a natural advection sensor; recording, using the stacked plurality of fiber optic sensors, a vertical distribution of time-series of temperature measurements; and determining the contribution of temperature changes at the ground surface caused by natural processes related to seasonal variations, weather systems and variations in climate, hereafter called the climate signal, to the temperature as a function of depth using a long-term record of surface temperature and an appropriate mathematical model that considers heat transfer by conduction; determining the contribution of precipitation, evaporation or evapotranspiration and freezing at the ground surface on the temperature as a function of depth using a long-term record of precipitation, evaporation, and temperature an appropriate mathematical model that considers effects of convective heat transfer and latent heat of fusion and latent heat of vaporization; correcting the vertical distribution of time-series of temperature measurements for strain measured by the strain sensor, natural advection measured by the natural advection sensor, and conductive and convective heating from the surface of the geographic area of interest by inverting a mathematical model that includes the climate signal, convective and latent heat effects and the geothermal heat flux using data describing the climate signal, convective and latent heat effects to generate estimates of the geothermal heat flux to obtain a corrected temperature gradient.

In one or more embodiments, the deploying comprises positioning the plurality of vertical profile temperature probes between four and fifteen meters beneath the surface of the geographic area of interest. In one or more embodiments, the recording the vertical distribution of time-series of temperature measurements occurs for a predefined duration occurring after identification of a thermal equilibrium following a disturbance event resulting from the deploying the plurality of vertical profile temperature probes.

In one or more embodiments, the method further comprises determining an equilibrium temperature for each vertical profile temperature probe of the plurality of vertical profile temperature probes. In one or more embodiments, the determining the equilibrium temperature for each vertical profile temperature probe comprises averaging the time-series of temperature measurements. In one or more embodiments, the correcting the vertical distribution of time-series of temperature measurements comprises correcting the equilibrium temperature for the strain measured by the strain sensor, the natural advection measured by the natural advection sensor, and the conductive and convective heating from the surface and latent heat of fusion and latent heat of vaporization of the geographic area of interest.

In one or more embodiments, the method further comprises generating a heat flow map for the geographic area of interest resulting from geothermal heat flux from corrected temperature gradients associated with the plurality of vertical profile temperature probes. In one or more embodiments, the heat flow map indicates a presence of commercial-grade geothermal heat resources when the corrected temperature gradients exceed a predefined threshold.

In one or more embodiments, the plurality of vertical profile temperature probes comprises at least three vertical profile temperature sensors each having at least two fiber optic sensors in the stacked plurality of fiber optic sensors. In one or more embodiments, the method further comprises obtaining a long-term surface temperature record for the geographic area and, with a numerical heat-transfer model, generating a depth-dependent function of temperature representing the conductive and convective heating from the surface due to climate surface and latent heat of fusion and latent heat of vaporization of the geographic area of interest on subsurface temperatures. In one or more embodiments, the corrected temperature gradient corresponds to a temperature signal generated by a geothermic energy source.

Turning now to FIG. 5, illustrated therein is one explanatory method 500 for acquiring and using terrestrial temperature measurements to quantify subsurface heat flow and formation thermophysical properties for locating and characterizing geothermal resources and for optimally designing geo-pressure and geothermal energy storage and geothermal heat pump systems; and particularly relates to vertical profile measurements acquired using an fiber optic instrument array and only taken to shallow depths, e.g., less than fifteen meters.

Embodiments of the disclosure contemplate that, on continents, geothermal heat flow (conductive steady-state heat flux) is a direct control on the thermal energy density available in the subsurface. Accordingly, geothermal heat flow can be a value of interest for geothermal resource exploration. Additionally, geothermal heat flow can be interesting as related to the design of systems for subsurface energy storage. It is known that heat flow (steady-state flux), q_{T}, is given by the following equation:

$${q}_{T} = {K}_{h} \frac{δ t}{δ z} \qquad ( Eq . 1 )$$

where Kₕ is the thermal conductivity of the formation material, t is temperature, and z is depth. Based on Eq. 1, the quantitative determination of heat flow from field measurements for geothermal resource exploration involves measuring the temperature in specially drilled boreholes, called temperature gradient holes (TGH), and by measuring in the laboratory the thermal conductivities of core samples taken from the borehole.

In prior art systems, the TGHs in which these measurements are made are commonly drilled to several hundred meters into the earth. Thereafter, temperature measurements are made in a vertical profile at discrete points usually spaced at least one meter apart. The vertical profile measurements are used to calculate the vertical temperature gradient,

$$\frac{δ t}{δ z} ,$$

and this value in combination with the laboratory measurements of Kₕ are used to calculate q_{T}, assuming that all heat transport is via conduction.

The approach to quantifying heat flow described above requires the use of a relatively deep borehole (again, hundreds of meters) to reliably estimate the values of interest, q_{T}. A relatively deep borehole is required because temperature variations with depth are a result of the superposition of different heating effects, and at shallow depths, e.g., less than fifteen meters, temperature variations are not just due to heating from geothermal heat flow, but are also subject to climate-driven heating of the ground surface, such that T(z)=T_{G}(z)+T_{C}(z), where T(z) is the temperature as a function of depth, T_{G}(z) is the temperature due to heating from geothermal heat flow (geothermal signal), and T_{C}(z) is the temperature due to climate driven heating of the ground surface (climate signal).

Important to the method 500 of FIG. 5, at shallow depths, heating due to the climate signal is large relative to heating from the internal earth (geothermal signal), which interferes with and masks the temperature due to geothermal heat flow. This is why using the temperature gradient obtained from measurements made at shallow depth to calculate heat flow is very likely to yield erroneous values of q_{T}.

Advantageously, the method 500 of FIG. 5 quantifies heat flow as a correct and reliable indicator of a geothermal heat resource from shallow depths (less than fifteen meters). The method 500 of FIG. 5 eliminates the need and expense of drilling hundreds of meters into the earth and instead can be accomplished using temperature measurements made at shallow depth. To accomplish this, the method 500 of FIG. 5 compensates and corrects for contributions to temperature readings arising from surface heating caused by solar and atmospheric processes, which are collectively referred to herein as the “climate signal.” The resulting, corrected vertical temperature distribution due to the geothermal signal then is used to quantify heat flow as a reliable indicator of a geothermal heat resource.

Accordingly, the method 500 of FIG. 5 provides a process for geothermal energy exploration. In this illustrative embodiment, the method 500 comprises steps and decision points aimed at quantifying geothermal heat flux and identifying viable geothermal energy sources. In essence, the method 500 leverages shallow subsurface temperature measurements, advanced modeling techniques, and geological projections to assess geothermal potential, thereby addressing the limitations of traditional deep borehole surveys.

In one or more embodiments, step 501 involves determining thermal conductivity at depth z and the surface, or soil, temperature at time t. These parameters are useful for understanding the thermal properties of the subsurface and serve as inputs for subsequent modeling and analysis. By way of example, thermal conductivity can be measured directly using extracted samples or estimated based on existing geological data, while surface temperature data is obtained from weather stations or historical climate records.

Subsequently, step 502 defines the locations and positions of sensors deployed across the site. Said differently, in one or more embodiments step 502 comprises defining a plurality of measurement sites along a geographic area of interest. In one or more embodiments, measurement sites are arranged in a grid or similar pattern, with spacing determined by geological features and specific survey objectives. This step is designed to achieve effective spatial sampling while minimizing redundant or insufficient data collection.

Turning now to step 503, in one or more embodiments the method 500 comprises deploying shallow subsurface measurement groups, typically at depths of less than fifteen meters, and subsequently allowing the system to reach thermal equilibrium. In one or more embodiments, each electronic sensor group deployed comprises a plurality of vertical profile temperature probes each comprising a stacked plurality of temperature sensors and a natural advection sensor.

In one or more embodiments, the plurality of vertical profile temperature probes deployed at step 503 comprises at least three vertical profile temperature sensors each having at least two fiber optic sensors in the stacked plurality of fiber optic sensors. In one or more embodiments, step 503 comprises positioning the plurality of vertical profile temperature probes between four and fifteen meters beneath the surface of a geographic area of interest.

When the stacked plurality of temperature sensors each comprise optical sensors defining a fiber Bragg grating, in one or more embodiments the deploying comprises deploying a strain sensor as well. One illustrative such deployment was shown above with reference to FIG. 1. In one or more embodiments, deployment methods such as direct-push technology or hydraulic drilling are employed to insert vertical profile temperature probes into the subsurface, thereby establishing the necessary conditions for accurate measurement.

In one or more embodiments, step 504 comprises making the initial temperature measurements and verifying the parameters. In one or more embodiments, this step 504 ensures that the deployed sensors are functioning correctly and that the collected data is valid. Thus, any anomalies or errors in the initial measurements are addressed before proceeding to further steps.

In a subsequent step, step 505 logs temperature measurements for a predefined duration. Examples of the predefine duration can vary, but in one or more embodiments the predefined duration is between twenty-four and forty-eight hours. Thus, in one or more embodiments, step 505 comprises recording, using the stacked plurality of temperature sensors, a vertical distribution of time-series of temperature measurements.

In one or more embodiments, step 505 comprises recording the vertical distribution of time-series of temperature measurements for a predefined duration occurring after an identification of a thermal equilibrium is received following a disturbance event resulting from the deploying the plurality of vertical profile temperature probes at step 503. During this period, the sensors record time-series temperature data at closely spaced intervals along the vertical profile, thereby capturing both the transient and equilibrium thermal conditions of the subsurface.

Thereafter, step 506 processes the temperature measurements, represented in the form T(z,t), to obtain T(z), which signifies the equilibrium temperature distribution as a function of depth. In this illustrative embodiment, statistical analyses are performed to identify noise characteristics and calculate uncertainty estimates for the temperature data. Said differently, in one or more embodiments step 506 comprises determining an equilibrium temperature for each vertical profile temperature probe of the plurality of vertical profile temperature probes deployed at step 503. In one or more embodiments, the determining the equilibrium temperature for the each vertical profile temperature probe comprises averaging the time-series of temperature measurements T(z,t) to obtain T(z).

In step 507, corrections are performed to eliminate the effects of surface heating and natural advection noise. Corrections for strain can also be performed at step 507. In some embodiments, as will be described below, the corrections use multi-year surface temperature records for the correction model. Accordingly, step 507 can optionally comprise obtaining a multi-year surface temperature record for the geographic area and, with a numerical heat-transfer model, generating a depth-dependent function of temperature representing conductive heating and the convective heating from climate upon the surface of the geographic area of interest on subsurface temperatures.

Thus, in one or more embodiments step 507 comprises correcting the vertical distribution of time-series of temperature measurements made at step 505 for natural advection measured by the natural advection sensor and conductive heating from a surface of the geographic area of interest to obtain, at step 508, a corrected temperature gradient.

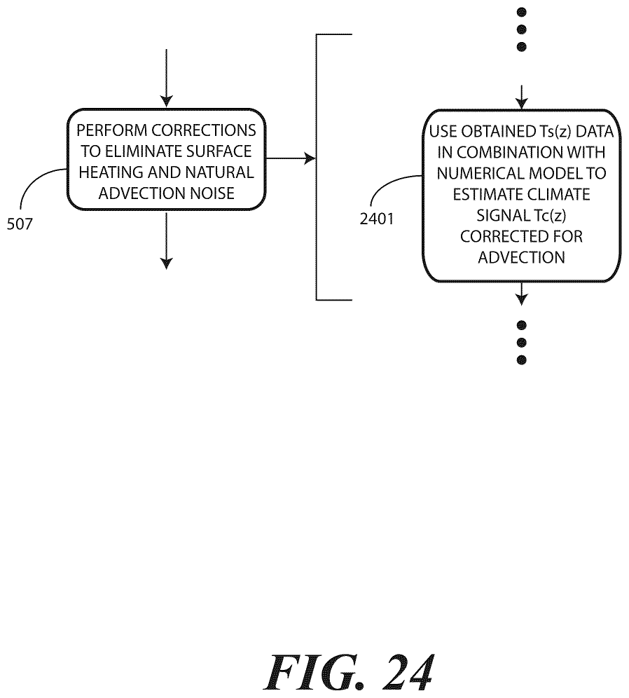

While FIG. 6 illustrates one explanatory method for performing step 507, embodiments of the disclosure are not so limited. Turning briefly now to FIG. 24, illustrated therein are one or more other method steps that can be performed at step 507 as well.

In one or more embodiments, step 507 comprises separating a contribution of geothermal heat flux from another contribution of heating of the surface of the geographic area from the time-series of temperature measurements, Tₛ(t), to obtain a magnitude of the geothermal heat flux. In one or more embodiments, this involves using the time series of temperature data in combination with an appropriate numerical model, as represented by step 2401, to estimate the climate signal, T_{c}(z), corrected for any advection. Attention will now be turned to the details of this appropriate numerical model.

At shallow depths, e.g., less than fifteen meters, embodiments of the disclosure contemplate that temperature variations occur due to geothermal heat flow from within the earth, as well as heating of the ground surface, such that

$$T ( z ) = {T}_{G} ( z ) + {T}_{C} ( z ) \qquad ( Eq . 2 )$$

where T(z) is the temperature as a function of depth, T_{G}(z) is the temperature due to heat flow upward from within the earth (geothermal signal), and T_{C}(z) is the temperature due to heat flow downward from the ground surface, referred to herein as the “climate signal.”

The subsurface temperature distribution resulting from downward propagating heat due to periodic fluctuations in land surface temperature can be quantified using a variety of analytical and numerical modeling approaches. The temperature of the ground surface is assumed to vary periodically over daily to annual periods or longer, which causes a periodic fluctuation in soil temperature that decays with depth. The rate of decay with depth is proportional to the frequency of the temperature fluctuations, so annual fluctuations penetrate much deeper than daily ones. Illustrated below is confirmation that fluctuations of temperature at the ground surface with a period of less than 1 month will have minor effects at depths greater than 4.6 meters. Our primary measurements are designed to be in the depth range of 4.6 to ten meters or deeper. This calculation justifies using monthly average temperatures to characterize the temperature record.

In a uniform material where all heat transfer is only by conduction, the subsurface temperature as a function of depth can be posed as a boundary value problem where a long-baseline data record of time-averaged surface temperature is used to define the upper boundary condition and an appropriate mathematical model is solved that includes T_{C}(z) (climate signal) as an unknown parameter. This could be accomplished using a forward modeling approach where the upper boundary condition is specified according to the surface temperature record.

As an alternative, an inverse modeling approach could be used where the contributions to the temperature at a given depth from both surface heating and from geothermal heat flux are represented in an expression such as Eq. 3. This expression will then be inverted using the surface temperature record and subsurface temperature measurements to separate T_{C}(z) (climate signal) from T_{G}(z) (geothermal signal), assuming all heat transfer is by conduction. In either modeling approach, the subsurface thermal properties are assigned according to laboratory measurements of field samples or from prior knowledge of subsurface lithology by additional numerical modeling or professional judgement. Both modeling approaches can be expanded to account for thermal advection and latent heating.

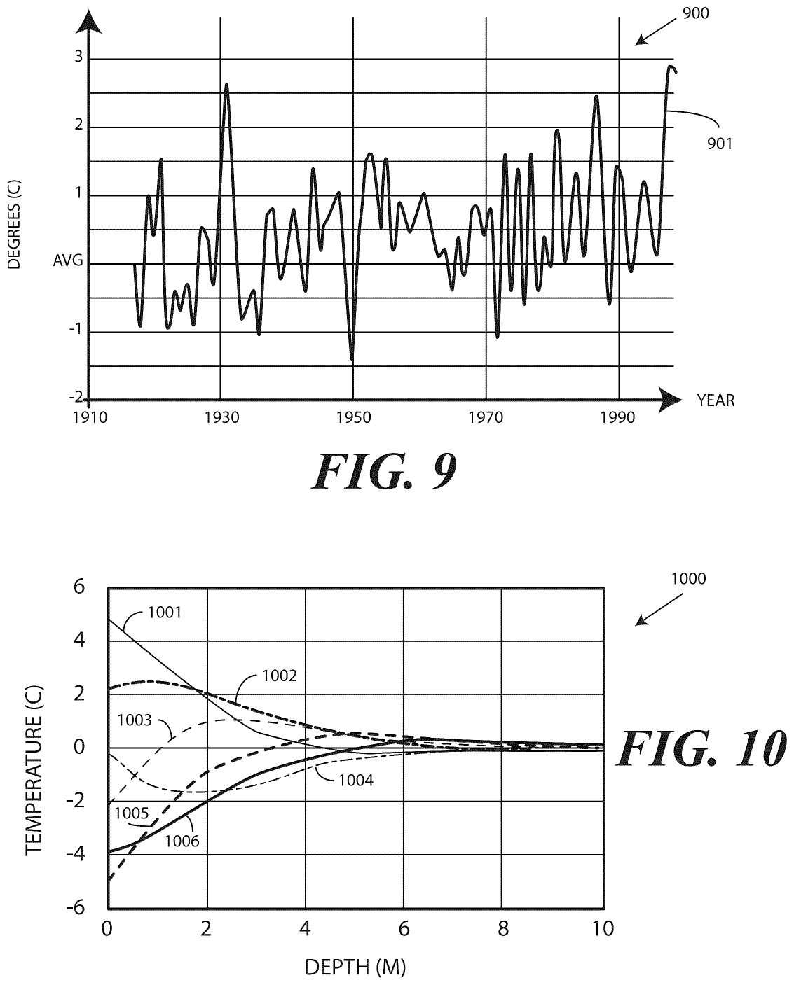

At step 2401, the contribution to the temperature at a given depth from heating of the ground surface (climate signal), T_{C}(z), is calculated using a time-series data record of long-term air and-or soil temperature Tₛ(t) from the measurement site area of interest, an example of which is shown in FIG. 9, and an appropriate mathematical model. The record of long-term air and-or soil temperature Tₛ(t) can be interpolated to the survey area by correlating data obtained from a weather station deployed for at least three months to surface temperature data collected for the same time period at nearby permanent regional climate monitoring stations. Alternatively, the air and soil temperature history can be derived from global models of atmospheric and ocean paleo-circulation.

The temperature caused by a periodically fluctuating temperature at the ground surface as shown here:

$${T}_{C 1} ( z ) = {T}_{0} {e}^{- z β} sin ( ω t - z β ) \qquad ( Eq . 3 )$$

The first term of the equation,

$${T}_{0} {e}^{- z β} ,$$

how the amplitude of the temperature varies as a function of depth (z), where Tₒ is the amplitude at the ground surface.

$$β = \sqrt{\frac{ω}{2 {D}_{T}}} ,$$

where D_{T} is the thermal diffusivity.

$$ω = \frac{2 π}{λ}$$

is the angular frequency, where λ is the period of the temperature variation at the ground surface. The second term in the equation, sin(ωt−zβ), is the phase retardation in the climate signal.

Heating at the ground surface involves signals with a range of periods from daily variations to year-long seasonal fluctuations, or El Nino variations of one to two years, or Pacific or Atlantic decadal oscillations lasting several decades, or even longer fluctuations. The effect of surface temperature includes the superposition of all of these variations, so

$${T}_{C} ( z ) = {\overline{T}}_{c} + {\sum }_{i = 1}^{n} {T}_{0 i} {e}^{- z {β}_{i}} sin ( {ω}_{i} t - z {β}_{i} ) \qquad ( Eq . 4 )$$

where n is the number of periods that are considered and the subscripted variables indicate the term for that period, and T̅_{c} is the average temperature at the ground surface.

Short-term variations in heating of the ground surface damp out quickly with depth and can be ignored when measurements are deep enough. Embodiments of the disclosure select 4.6 meters as the shallowest depth expected to make meaningful measurements. Accordingly, an evaluation of the period of fluctuation that would damp out to 0.01T₀ᵢ at d=4.6 m is performed. Setting the exponential term in the summation in (3) to 0.01

$$0.01 = {e}^{- z \sqrt{\frac{π}{{λ}_{c} {D}_{T}}}} \qquad ( Eq . 5 )$$

Using z=5 m and assuming 0.3×10⁻⁶<D_{T}<1×10⁻⁶ m²/s as typical values for the thermal diffusivity of soil (low end of the range) or rock (high end of the range) and then solving (4) for l_{c} gives

$${λ}_{c} \approx 1.4 to 4.3 months \qquad ( Eq . 6 )$$

This means that temperature fluctuations with periods shorter than one to several months can be ignored because they will have negligible effect on temperature below five meters. This is convenient because many extended temperature records are based on monthly average temperatures.

The amplitude of seasonal variations in temperature (period of one year) will decay to approximately 0.06 at a depth of five meters in dry sand (which is common in basins in the western U.S.). The annual variations will decay to 0.00014 at fifteen meters depth in sand, according to the assumptions above.

The amplitude of annual variations in temperature (half the annual range) is 10 to 20 degrees centigrade in the western U.S. As a result, temperatures are expected to vary by approximately +/−1 degrees centigrade at five meters depth and this variation decreases to +/−0.01 degrees centigrade at twelve meters and +/−0.002 degrees centigrade at fifteen meters depth over an annual period in sand as a result of seasonal temperature fluctuations.

The temperature change from the average surface temperature resulting from geothermal heat flow in a uniform material can be represented as

$${T}_{G} ( z ) = \frac{{q}_{T}}{{\overline{K}}_{h}} z \qquad ( Eq . 7 )$$

where q_{T} is the geothermal heat flux, and K̅ₕ̅ is depth-averaged thermal conductivity. Equation 7 can be rewritten in terms of the temperature gradient as follows

$${dT}_{G} = \frac{δ {T}_{G}}{δ z} = \frac{{q}_{T}}{{\overline{K}}_{h}} \qquad ( Eq . 8 )$$

where

$$\frac{δ T}{δ z}$$

is the temperature gradient in the vertical direction. Equation 8 can be written to show the relationship between the temperature gradient and geothermal heat flux according to Fourier as follows:

$${q}_{T} = {\overline{K}}_{h} \frac{δ {T}_{G}}{δ z} \qquad ( Eq . 9 )$$

Substituting Equation 4 and Equation 9 into Equation 2 gives the temperature as function of depth as follows:

$$T ( z ) = {\overline{T}}_{c} + {\sum }_{i = 1}^{n} {T}_{0 i} {e}^{- z {β}_{i}} sin ( {ω}_{i} t - z {β}_{i} ) + \frac{{q}_{T}}{{\overline{K}}_{h}} z \qquad ( Eq . 10 )$$

Geothermal exploration involves trying to estimate the temperature of a geothermal resource T(d_{GR}) at depth d=d_{GR} using measurement at shallow depth where T_{C}>>T_{G}. An ideal approach conceptually is to measure q_{T} and estimate K̅ₕ̅ and then use Equation 7 and the average surface temperature T̅_{c} to estimate T(d_{GR}).

The problem with using Equation 7 is that temperature measurements at shallow depths will follow from Equation 10. Accordingly, the summation term from surface heating must be characterized and subtracted from Equation 10 to produce Equation 7.

This could be accomplished by fully characterizing the effects of surface heating using records of monthly average temperatures and either Equation 4 or a numerical forward model using a finite element or finite difference method where the upper boundary condition is specified according to the surface temperature record Tₛ(t). The model sides and bottom would be assigned as no flow boundaries and subsurface thermal properties are specified according to laboratory measurements of field samples or from prior knowledge of subsurface lithology. The downward direction of heat flow would be specified and the model stepped forward in time to calculate the temperature as a function of depth due to surface heating, T_{C}(z).

Equation 3 can be expanded to include the contribution to temperature at a given depth from both surface heating and heating from geothermal heat flux:

$$T ( z ) = {T}_{0} {e}^{- z β} sin ( ω t - z β ) + \frac{{q}_{T}}{{K}_{h}} z \qquad ( Eq . 9 )$$

The last term,

$$\frac{{q}_{T}}{{K}_{h}} z ,$$

is temperature from geothermal heat flow as a function of depth (z), where q_{T} is the geothermal heat flux, and Kₕ is thermal conductivity.

An example approach to modeling the climate signal, is a two-step inversion process that considers heating from the surface and from geothermal heat flux where the first step uses a fast analytical model to characterize the temperature distribution and the second step uses a slower, but more detailed numerical model. In this approach T_{C}(z) is quantified implicitly by using the surface temperature record and the subsurface vertical profile temperature measurements to calculate geothermal heat flux, q_{T}. The amplitudes and phases of the dominant harmonics of the climate signal are obtained using a Fourier transform of the surface temperature time series. The temperature would be represented using Equation 4. This expression could either be subtracted from the observed temperature or evaluated using inversion.

The results of the first step will be used to populate a numerical model with variable thermal properties. For example, the analysis could consider ten layers, each with an unknown D_{T} and Kₕ. The model will be inverted to evaluate heterogeneity in thermal properties and to refine estimates of q_{T}. The final result will yield the estimate q_{T} with uncertainty assuming heat transfer is limited to thermal conduction.

In the case that advection is detected in the measurement site area, the technique can readily be expanded to evaluate the effects of thermal advection caused by infiltration, or by barometric pumping. This will be accomplished by modifying the numerical model to include effects of multiphase flow during heat transfer. Effects of freezing in the temperature record can be accommodated by including storage as latent heat in the model.

Turning now back to FIG. 5, in one or more embodiments, the corrected temperature gradient obtained at step 508 corresponds to a temperature signal generated by a geothermic energy source. In one or more embodiments, the correcting the vertical distribution of time-series of temperature measurements at step 507 comprises correcting the equilibrium temperature for the strain measured by the strain sensor, the natural advection measured by the natural advection sensor, and the conductive heating from the surface of the geographic area of interest.

Turning now briefly to FIG. 6, illustrated therein are one or more method steps illustrating how the corrections can be performed at step 507. Others will be obvious to those of ordinary skill in the art having the benefit of this disclosure.

The method steps for correcting temperature measurements obtained from vertical profile temperature sensors thereby isolate the geothermal heat signal from external influences such as surface heating and natural advection. In this context, these corrections play an impactful role in ensuring the accuracy of geothermal heat flux quantification at shallow depths.

In one or more embodiments, step 507 is executed to perform corrections aimed at eliminating surface heating and natural advection noise. This step 507 refines the raw temperature data collected by the vertical profile temperature sensors. Accordingly, the corrections address the interference caused by climate-driven surface heating and by fluid movement within the subsurface.

In one or more embodiments, step 601 obtains both advective and conductive sensor measurements from the natural advection sensor. In some embodiments, these measurements are collected using both the natural advection sensors and strain sensors deployed alongside the vertical profile temperature probes. The advective heat sensor is utilized to detect heat transport effects driven by fluid movement, while concurrently, the strain sensor measures mechanical strain that may otherwise distort the temperature readings (when optical temperature sensors are used, as optical temperature sensors capture measurements of strain as a proxy for temperature).

Thereafter, in step 602, the measurements obtained in step 601 are employed to model natural advection caused by prevailing climate conditions. In one or more embodiments, the modeling process involves analyzing the asymmetries in the temperature disturbances recorded by the advective heat sensor.

In one or more embodiments, to evaluate the thermal regime at shallow depth, step 602 assumes heat transfer in the soil from surface heating only occurs by conduction. In one or more embodiments, an equation defining the temperature variation is as follows:

$$T = {T}_{0} {e}^{- z β} sin ( ω t - z β ) + \frac{{q}_{T}}{{K}_{h}} z \qquad ( Eq . 10 )$$

The first term of the equation,

$${T}_{0} {e}^{- z β} ,$$

is the amplitude of the climate signal as a function of depth (z), where Tₒ is the ground surface temperature.

$$β = \sqrt{\frac{ω}{2 {D}_{T}}} ,$$

where D_{T} is the thermal diffusivity, and

$$ω = \frac{2 π}{λ} ,$$

gives the angular frequency, where λ is the period of the temperature variation at the ground surface.

The second term in the equation, sin(ωt−zβ), is the phase retardation in the climate signal. The last term,

$$\frac{{q}_{T}}{{K}_{h}} z ,$$

is temperature from geothermal heat flow as a function of depth (z), where q_{T} is the geothermal heat flux, and Kₕ is thermal conductivity. As a result, step 602 quantifies both the magnitude and direction of fluid movement, which is then used to characterize the advective heat transport effects on the subsurface temperature profile.

Moving forward, step 603 is implemented to filter out the natural convection component from the recorded temperature sensor measurements. In one or more embodiments, by applying the advective heat transport model developed in step 602, this step effectively removes the influence of fluid movement from the temperature data. Thus, the temperature profile is rendered to reflect solely the conductive heat transport, which is necessary for isolating the geothermal heat signal.

In a similar manner, step 604 filters out the temperature signal arising from surface heating from the measurements. In some embodiments, this step utilizes long-term surface temperature records and mathematical models to estimate the downward propagation of surface heating effects. Accordingly, a digital filter is applied to differentiate and separate the climate signal from the temperature profile, leaving behind the geothermal component.

Step 605 completes the correction process by obtaining the signal of interest. In one or more embodiments, this signal represents the adjusted temperature profile attributable solely to geothermal heat flux, now free from the interferences of surface heating, natural advection, and strain. As a result, the adjusted data may then be utilized to calculate geothermal heat flow and to generate heat flow maps for resource assessment.

Thus, as depicted in the flowchart of FIG. 6, a systematic approach is illustrated for refining temperature measurements, ensuring that the geothermal heat signal is accurately isolated and quantified. In this manner, the methodology addresses the challenges posed by external influences, thereby enabling reliable geothermal exploration and resource evaluation.

To further illustrate these method steps, in one or more embodiments step 602 comprises obtaining a time-series data record of long-term air and-or soil temperature of the survey area of interest. This data can be used as input data to a modeling process where the temperature as a function of depth due to ground surface heating (climate signal) is calculated for removal at step 504.

In one or more embodiments, the subsurface temperature distribution resulting from downward propagating heating due to periodic fluctuations in land surface temperature can be quantified using a variety of analytical and numerical modeling approaches. The temperature of the ground surface is assumed to vary periodically over daily to annual periods, which causes a periodic fluctuation in soil temperature that decays with depth. The rate of decay with depth is proportional to the frequency of the temperature fluctuations, so annual fluctuations penetrate much deeper than daily ones.

In a uniform material where all heat transfer is only by conduction, the subsurface temperature as a function of depth can be posed as a boundary value problem where a data record of time-averaged surface temperature is used to define the upper boundary condition and an appropriate mathematical model is solved that includes T_{C}(z) (climate signal) as an unknown parameter. Once the temperature as a function of depth due to the climate signal is calculated at step 602, at step 604 it is subtracted from the vertical profile temperature measurements collected at each measurement site.

The residual in the measured temperature time-series yields a distribution of point measurements of temperature due to geothermal heat flux (geothermal signal) assuming all heat transport in the material is conductive. The temperature gradient calculated from the measured vertical distribution of temperature after accounting for the climate signal is used in combination with thermal conductivity values for the measurement site area at the depth of the shallow survey to quantify geothermal heat flow at each measurement site.

Embodiments of the disclosure contemplate that it can be important to test the assumption in the survey area of interest that heat transport is only or mostly by conduction, and if it is indicated that there is significant advection (vertical or horizontal flow of fluids through the subsurface formation at the site), then this second heat transport mechanism be accounted for in the modeling of the vertical temperature distribution due to the climate signal described above. As noted above, in one or more embodiments one or more advective heat sensor(s) are deployed coincident with and to the same depth as the vertical temperature probes for each shallow-depth temperature survey or survey segment.

At step 601, readings from these natural advection sensors are captured to detect and characterize heat transport by advection. In one or more embodiments, the advective heat sensor is designed to perform a thermal response test in which the temperature disturbance (heat pulse) created by an artificial heat source of known power propagates spherically outward and is recorded by a group of temperature sensors spaced at a close distance apart, e.g., between one and five centimeters, and arrayed concentrically around the centrally located point heat source.

As described above with reference to FIG. 3, in one or more embodiments the advective heat sensor is contained within a perforated cylindrical housing so that fluids in the subsurface can flow freely around the sensor. The heat source generates a heat pulse that is recorded as time series data at each temperature sensor location.

In one or more embodiments, if the temperature recorded by the array of temperature sensors as a function of time and distance from the heat source is the same (i.e. the heating front is propagating outward symmetrically), then this is used as an indication that heat transport is all or mostly by conduction. If the temperature recorded by the array of temperature sensors as a function of time and distance from the heat source is not the same, however, (i.e. the heating front is propagating outward asymmetrically), then this is an indication of significant advection. Moreover, the asymmetry of the propagating heating front can be used to estimate the magnitude and direction of the fluid velocity in the formation, which can be used to model the effect of advection on the vertical temperature distribution resulting from the climate signal so that the same can be removed at step 603.

A few examples will beneficially further illustrate how step 507 can be performed in FIG. 6. Consider a first example:

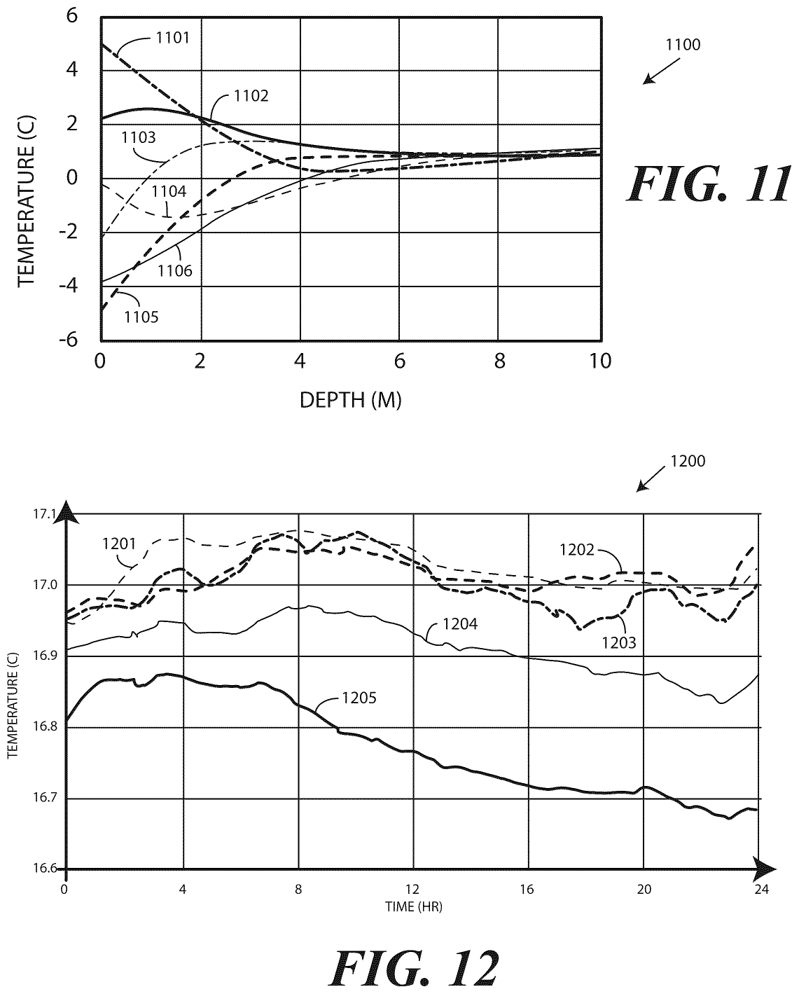

As a nonlimiting illustration of how the thermal regime at shallow depth can be interrogated to disentangle the value of interest, i.e. the temperature signal from geothermal heat flux, from the temperature signal from surface heating due to climate to yield an accurate estimate of the value of interest, turn briefly to FIGS. 10-11. In FIG. 10, a graph 1000 showing six temperature distributions 1001, 1002, 1003, 1004, 1005, 1006 have bene generated by a synthetic model based upon deviations from a mean temperature across ten-meter depth of soil with average properties. In FIG. 11, another graph 1100 showing six temperature more distributions 1101, 1102, 1103, 1104, 1105, 1106 have bene generated by the synthetic model. The graphs 1000, 1100 are used to evaluate the expected variations in temperature with depth and time.

To generate the temperature distributions 1001, 1002, 1003, 1004, 1005, 1006 of FIG. 10, one set of calculations was performed using an average value of geothermal heat flux, q_{T}=0.025 W/m². To generate the temperature distributions 1101, 1102, 1103, 1104, 1105, 1106 of FIG. 11, another was performed using a relatively high value to evaluate effects of q_{T} on the temperature profile.

The temperature profiles vary markedly throughout the year at depths above six to eight meters. This is due to the variations at the ground surface, as shown in FIGS. 10-11. For example, at a depth of two meters, the temperatures fluctuate by plus or minus two degrees centigrade for both values of q_{T}. This underscores the difficulty in estimating heat flux with a single shallow point measurement.

However, embodiments of the disclosure stand for the proposition that the geothermal heat flux clearly affects the temperature profile. The differences are most apparent at depths below six meters where the temperature profile for the case with q_{T}=0.1 W/m² is clearly steeper than the profile for q_{T}=0.025 W/m². This is why deep measurements of the temperature gradient can be used to accurately estimate geothermal heat flux.

However, in understanding the present disclosure it is important to recognize that the differences in temperature profiles at depths below six meters also occur in the profiles at shallower depths. They are obscured from casual visual inspection by the large temperature fluctuations caused by heating at the ground surface. However, q_{T} affects the shallow temperatures still. This is why interrogation of the thermal regime at shallow depth in accordance with embodiments of the disclosure can be used to estimate geothermal heat flux by measuring a vertical temperature profile, obtaining a long baseline of historical surface temperature to model the climate signal, and then solving an appropriate mathematical model (Eq. 2) that includes q_{T} as an unknown parameter in order to isolate the value of interest, the temperature due to geothermal heat flux.

Turning now back to FIG. 5, in one or more embodiments step 507 can, optionally using long-term surface temperature records and mathematical models, filter out the climate signal and advective heat transport effects, thereby isolating the geothermal heat signal in a manner analogous to refined data processing techniques. In one or more embodiments, step 508 calculates the temperature gradient and heat flow. In this process, the corrected temperature gradient, expressed as δT/δz, is combined with thermal conductivity Kₕ to quantify the geothermal heat flux, q_{T}, which serves as an indicator of geothermal energy potential.

The value of heat flow at each measurements site determined at step 508, which accounts for the effects of the climate signal and advective heat transport, can be plotted to produce contour maps as a direct indicator of a geothermal heat resource. In addition, other available geological information can be used to construct a geological model of the subsurface formations, adjusting for topography, and-or other disturbing influences.

Accordingly, optional step 509 can comprise generating geothermal heat flow maps and producing an integrated geologic model. In one or more embodiments, step 509 comprises generating a heat flow map for the geographic area of interest resulting from geothermal heat flux from corrected temperature gradients associated with the plurality of vertical profile temperature probes. In one or more embodiments, the heat flow maps visually represent the spatial distribution of geothermal resources, while the geologic model integrates the corrected temperature data with geological information to provide a comprehensive subsurface assessment.

At step 510, the geologic model is used to project heat flow downward, thereby estimating geothermal heat flux at greater depths while accounting for variations in thermal conductivity and geological formations. This step 510 illustrates the method's ability to extend predictive insights beyond the immediate measurement domain.

In one or more embodiments, step 510 comprises comparing the aforementioned model with the (corrected) measurements of the vertical temperature distribution at the depth of the temperature survey. The model can be modified until a satisfactory fit is achieved between the model and the heat flow map, thus improving the subsurface model by subjecting it to reliable temperature measurement data. The temperatures at the depth of the temperature survey can also be projected downward at step 510 into the modeled formations correcting for factors such as thermal conductivity variations with depth and changes in the formation pore fluids to quantify available geothermal resources, e.g. estimate the amount of heat in place.

At decision 511, the method evaluates whether the projections indicate the presence of geothermal energy. In one or more embodiments, the heat flow map indicates a presence of commercial-grade geothermal heat resources when the corrected temperature gradients exceed a predefined threshold. Decision 511 can determine whether the corrected temperature gradients exceed this predefined threshold in one or more embodiments. Where true, i.e., if the projections confirm viable geothermal resources, the method 500 proceeds to step 512. conversely, if the projections do not support viable resources, the method 500 instead moves to step 513.

In step 512, the method 500 comprises exploiting the identified geothermal energy source, thereby utilizing the resource for energy production or for other applications, as appropriate. Conversely, in step 513, if the current site does not yield viable geothermal resources, the method 500 can stop and be moved so as to be applied to a new location of interest. In this manner, the process ensures continuous exploration and resource assessment across alternative sites.

Thus, the flowchart depicted in FIG. 5 provides a systematic approach to geothermal exploration, wherein each step and decision point is oriented toward achieving an accurate and efficient assessment of geothermal energy potential. One point of note about the method steps and decisions of FIG. 5 is the recognition that temperature measurements taken over a depth interval as small as one meter by a shallow-depth temperature probe rather than over hundreds of meters in a TGH, if taken in the manner described in FIG. 5, can be used to disentangle the signal of interest—the temperature distribution and heat flow due to deep geothermal heat flux—from the disturbing influence of surface heating due to climate, which is much greater in magnitude at shallow depth.

Another important aspect is the realization that the corrected near-surface temperature distribution can be used to calibrate a subsurface geologic model that predicts geothermal heat flow and that thereby heat flow values obtained at the depth of the shallow survey can be projected downward to estimate the quantity of geothermal heat resources in place at the depths where these resources would be extracted for commercial purposes. Other advantages offered by the method 500 of FIG. 5 will be obvious to those of ordinary skill in the art having the benefit of this disclosure.

In an explanatory embodiment, a prospective subsurface area suitable for the method 500 of FIG. 5 can be chosen on the basis of prior knowledge of its geology and potential to host geothermal heat resources. In one or more embodiments, this prior knowledge can be obtained from studies that may include field mapping of hot springs, fumaroles, and faults, previously drilled THGs, seismic surveys, or from other sources.

Additionally, information about the thermal conductivity of the shallow subsurface and about the long-term (e.g., seasonal, inter-annual, decadal) air and-or soil temperature variation of the area can be beneficial in making the corrections at step 507. Illustrating by example, the thermal conductivity can be measured using, for instance, a conventional needle probe, or alternatively, it can be estimated from existing information on the subsurface lithology.

The long-term air and soil temperature can be measured by deploying a weather station at the area of interest and recording the temperature frequently enough (e.g. hourly, daily, or weekly) over a long enough period of time (e.g. at least three to six months and preferably a year) that the data can be used to interpolate a decadal-scale temperature record available from permanent regional climate monitoring stations. Alternatively, the air and soil temperature history can be derived from global models of atmospheric and ocean paleo-circulation.

In one or more embodiments, step 507 comprises determining two parameters of interest: Kₕ(z), which is the thermal conductivity Kₕ at depth z in the measurement site area (z is the depth interval of interrogation by the vertical profile temperature probe) and Tₛ(t), which is the surface air and-or soil temperature at time t in the measurement site area of interest. In one or more embodiments, these measurements are taken at sufficiently frequent intervals, e.g. hourly, daily, or weekly, for a sufficiently long period of time, e.g. inter-annual periods, decadal periods, and so forth.

The parameter Kₕ(z) can be measured by taking core samples and performing conventional needle probe thermal conductivity testing. If the geologic material in the shallow subsurface is known to be substantially uniform over the area of interest, then a single core sample can suffice. Otherwise, a sufficient number of core samples should be taken to be a representative sample of the variability of Kₕ(z) in the area of interest.

If the thermal conductivity is found not to change over the depth interval to be interrogated by the vertical profile temperature probe, then Kₕ(z) can be taken as a constant. Alternatively, Kₕ(z) can be estimated from existing information on the subsurface lithology, including core samples or cuttings previously collected by geological surveys or academia, or as a result of drilling activities for water, or by the petroleum or geothermal industries.

The parameter Tₛ(t) can be measured by deploying a weather station at the area of interest, programming the data logger to collect measurements at the required temporal sampling frequency, and leaving the station in the field for the requisite period of time. Weather station data can then be used to interpolate a decadal-scale temperature record available from permanent regional climate monitoring stations by correlating the time-series surface temperature data from the permanent monitoring station network to that collected by the weather station in the measurement site area for the same (recent) period of time. Alternatively, the air and soil temperature history can be derived from global models of atmospheric and ocean paleo-circulation.

To provide context and use cases for the method 500 of FIG. 5, at step 502 an array of measurement sites is selected. In many instances, these sites will be selected in a grid pattern. Sometimes, some knowledge of the subsurface geology is beneficial so that the chosen distance between measurement locations in a given direction avoids repeated surveying of the same temperature distribution from site to site while, at the same time, also avoiding abrupt changes in the temperature distribution between adjacent sites.

For example, if a survey area includes a linear fault trace at the surface, then measurement sites close to the fault can be more closely spaced, e.g., fifty to two hundred meters, and less closely spaced elsewhere, e.g. five hundred meters to one and a half kilometers. Similarly, if the survey area contains a symmetrical pluton or igneous complex, then the grid of measurement sites can be spaced more closely above and at the edges of the pluton, e.g., twenty-five to one hundred and fifty meters, and less closely away from the pluton, e.g., half a kilometer.

In one or more embodiments, the vertical profile temperature sensor deployed at step 503 comprises a special high precision, e.g., millikelvin temperature probe, with a series of closely spaced (each spaced between five and twenty-five centimeters apart along the device housing) temperature sensing points along the vertical length of the device housing. In one or more embodiments, the deployment of step 503 comprises inserting the vertical profile temperature probes into the shallow subsurface to a depth of at least four meters to measure the temperature distribution over a depth range.

In one or more embodiments, the vertical profile temperature probes can be deployed at step 503 into the subsurface using a direct-push technology, such as a Geoprobe.sup.™, or a hollow stem auger. In other embodiments, a hydraulic rock drill or percussive hammer can be used to deploy the vertical profile temperature probes. Such a method is advantageous when the soil contains crystalline rocks or other hard objects.

In one or more embodiments, step 503 comprises deploying several vertical profile temperature probes, e.g. a minimum of between nine and twelve, in a single survey or survey segment. The vertical profile temperature probes can be deployed at step 503 one after the other in one or more embodiments. In other embodiments, the vertical profile temperature probes can be deployed at step 503 simultaneously if more than one deployment rig is being used. Multiple vertical profile temperature probe deployment allows as little time as possible to elapse before all of the probes in the survey or survey segment are deployed.

In one or more embodiments, step 505 comprises recording a time series (sequence) of temperature measurements made at each sensing point along each temperature sensor in the sensing array. In some embodiments, selected measurements from each probe site are checked at step 504 as indicators of suspicious or invalid data or to determine whether the initial choice of spacing distance between measurement sites needs to be revised and, if so, by how much. After the requisite subsurface temperature measurements are made at step 505, the probe can be withdrawn and the drill stem removed.

Embodiments of the disclosure contemplate that the thermal regime at shallow depth is characterized by the periodic fluctuation of the temperature of the ground surface that decays with depth, referred to herein as the “climate signal,” and the superimposed uniform upward heat flux from geothermal heat flow, referred to herein as the “geothermal signal.” Embodiments of the disclosure contemplate that the upward thermal gradient is small compared to the temperature fluctuations at shallow depth, and this makes it difficult for point measurements of temperature to distinguish the effects of the upward gradient from the surface fluctuations. The method 500 of FIG. 5 contemplates that it is feasible to distinguish these two effects-the upward thermal gradient from geothermal heat flow and the downward propagating climate signal-using precise measurements of the vertical temperature distribution and independent long-baseline measurements of time-averaged surface temperature in combination with an appropriate mathematical modeling method.

In one or more embodiments, step 502 comprises selecting a suitable pattern for the array of measurements sites. As shown in FIG. 8, three grid sections 801,803,804 are shown, each including nine TGH openings 802 at the geographic location of interest. These grid sections 801,803,804 defined a grid pattern and can be extended based on the subsurface structure. In one or more embodiments, the extension is based upon knowledge of the subsurface structure taken from sources such as geologic structure maps made from measurements taken in the field. The definition of the grid at step 502 can also be made based upon previously obtained gravity, magnetic, or seismic surveys, drill records, or other sources.

In one or more embodiments, the orientation and spacing between measurement sites in the array should be chosen such that the distance between measurement locations in a given direction would avoid repeated surveying of the same vertical temperature distribution from site to site. Moreover, the spacing should avoid abrupt changes in the temperature distribution between adjacent sites.

For example, if a survey area includes a planer fault, then measurement sites close to the fault can be more closely spaced, e.g. between fifty and two-hundred meters, and less closely spaced elsewhere, e.g., between five hundred meters and one and a half kilometers. Similarly, if the survey area contains a symmetrical pluton or igneous complex, then the grid of measurement sites can be spaced more closely above and at the edges of the pluton, e.g. between twenty-five and a hundred and fifty meters, and less closely away from the pluton, e.g., half a kilometer, as noted above.

In one or more embodiments, step 503 comprises a vertical profile temperature probe by insertion into the subsurface to shallow depth at a distance between four and fifteen meters at each measurement site in the grid (one example of which is shown in FIG. 8). Step 505 can then comprise recording a time-series of vertical profile measurements T(z, t). One example of such a time series of vertical profile measurements 1201, 1202, 1203, 1204, 1205 is shown in the graph 1200 of FIG. 12. Each represents a measurement of the temperature T at depth z measured at time t. Downloading from a datalogger at least a selection of measurements for quality examination can occur as well.

Step 506 of FIG. 5 can perform processing operations on these vertical profile measurements (1201, 1202, 1203, 1204, 1205). Illustrating by example, in one or more embodiments step 506 comprises processing and displaying vertical profile measurements (1201, 1202, 1203, 1204, 1205) as shown in FIG. 12 to verify parameters like the expected approximately fixed spacing between temperature measurement points in each vertical profile and whether valid data has been acquired, etc.

In one or more embodiments, the results, an example of which are shown in the graph 1500 of FIG. 15, give a preliminary vertical temperature distribution or calculated heat flow value. This value can be used to revise the location(s) or chosen distance(s) between measurements sites in the array. Illustrating by example, profile 1501 is as expected due its continuous and smoothly increasing curve as a function of depth. By contrast, profile 1502 takes a decreasing turn after initially increasing, which may indicate that the vertical profile temperature probes are not properly coupled to the soil particles and should be repositioned.

Thus, referring again to FIG. 5, step 504 can comprise displaying at least selected curves such as the temperature-vs.-time curve or a curve of T(z) versus depth for a given measurement site to verify parameters such as (i) whether invalid data has been collected. As noted with reference to FIG. 15, profile (1501) is a smooth curve. Abrupt changes, like that shown in profile (1502) can indicate invalid data due to, for example, poor coupling between one or more temperature measurement points along the vertical probe and the formation or improper function of the opto-electronics.

Step 504 can also indicate whether the selection of the measurement sites in the array is suitable and consistent with the initial knowledge of the subsurface geology and lithology (e.g. if the T(z) versus depth curve for a given site is very different from that of another adjacent site. If not so, perhaps the array spacing should be decreased or an additional measurement site(s) should be added between the two greatly differing sites. Similarly, if the profiles are nearly identical, then perhaps the array spacing should be increased. Profiles such as profile (1502), since moving in accordance with erratic and possibly invalid data suggest a new site very close to the original should be surveyed.

Referring again to FIG. 5, at step 505 the batch of vertical profile temperature probes can, if temperature measurements are being made serially, be retrieved from the array of measurement sites in the survey or survey segment and either redeployed to new measurements sites or redeployed to the next array of measurement sites. This process can continue until the full measurement site is surveyed.

At step 506, the batch of vertical profile temperature probes is retrieved and the complete T(z, t) record for each measurement site is downloaded. The complete temperature-vs.-time measurements are processed by computer and statistical analyses are performed.

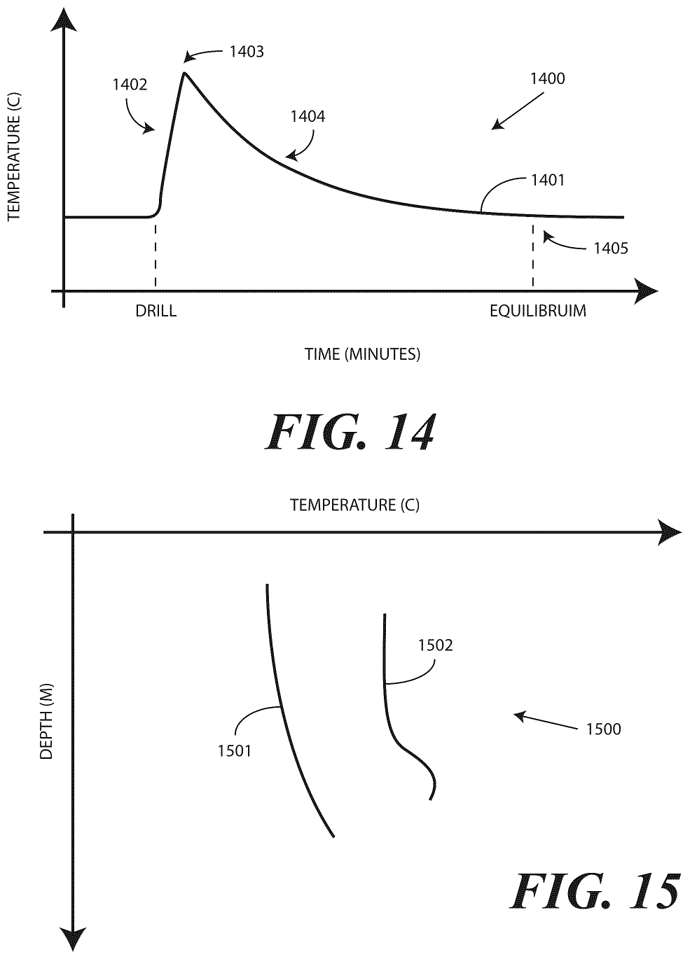

Embodiments of the disclosure contemplate that insertion of the vertical profile temperature probes can affect the temperature of the surrounding soil. Illustrating by example, turning briefly to FIG. 14, insertion can cause a rise 1402 in temperature 1401 to an apex 1403. Once the vertical profile temperature probes are placed, however, the temperature 1401 shown in this graph 1400 decays 1404 to an equilibrium level 1405.

Turning now back to FIG. 5, at step 504 the early part of the time series data record, e.g., the first three to twelve hours, which records the heating event associated with the deployment of the vertical profile temperature probe into the subsurface, can be processed to infer thermo-physical properties of the subsurface materials. At step 506 statistical analyses can be performed on the remainder of the time series dataset that records the temperature after the frictional heating event has dissipated, and the equilibrium temperature has been restored.

In one or more embodiments, the purpose of the statistical analysis is to identify the noise characteristics of the time series measurement set for removal at step 507. This can include defining the signal-to-noise ratio, differentiating random noise from coherent noise, and seeking to understand coherent noise events in the context of causative natural phenomena and in light of data collected by the advective heat sensor(s) deployed coincident with one or more measurement sites in the array for each survey or survey segment.

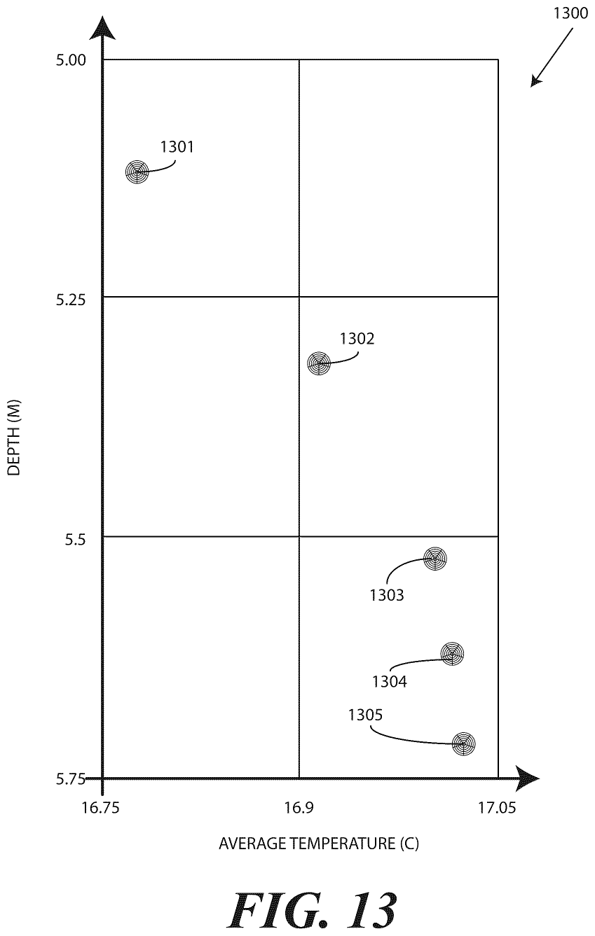

The result of 506 is that for each measurement site there is a respective statistical distribution of temperature values for each of a succession of temperature measurement (sensing) points along the vertical profile, each at a respective depth into the formation (determined by the position of the respective temperature measurement point along the vertical profile temperature probe and knowledge of how deep the probe was inserted into the subsurface). For each statistical distribution of temperature values, an equilibrium temperature (1301, 1302, 1303, 1304, 1305), examples of which are shown in the graph (1300) of FIG. 13, along with a corresponding standard deviation, can be calculated to produce a vertical (spatial) temperature distribution T(z), as shown in FIG. 4, and an uncertainty estimate for each succession of equilibrium temperatures. The uncorrected equilibrium temperature T(z) calculated for a given depth z.

In one or more embodiments, as shown in FIG. 15, which shows a graph 1600 of six temperature profiles 1601, 1602, 1603, 1604, 1605, 1606 that result from the superposition of two heating effects, one from geothermal heat flow, the value of interest, and the second from climate-driven heating of the ground surface, such that T(z)=T_{G}(z)+T_{C}(z), where T_{G}(z) is the temperature due to heating from geothermal heat flow (geothermal signal) and T_{C}(z) is the temperature due to climate driven heating of the ground surface (climate signal). It is therefore important to account for the downwardly propagating heat flow due to the climate signal by finding its contribution to the equilibrium temperature measured at a particular depth for a particular measurement site.

Thus, referring again to FIG. 5, at step 507 the contribution of the climate signal as a function of depth, T_{C}(z), i.e. the temperature at a given depth due to climate-driven heating of the ground surface, is estimated using a time-series data record (901) of long-term air and-or soil temperature Tₛ(t) from the measurement site area of interest, an example of which is shown in the graph (900) of FIG. 9, and an appropriate mathematical model. The record (901) of long-term air and-or soil temperature Tₛ(t) can be interpolated to the survey area by correlating data obtained from a weather station deployed for at least three months to surface temperature data collected for the same time period at nearby permanent regional climate monitoring stations.

Alternatively, the air and soil temperature history can be derived from global models of atmospheric and ocean paleo-circulation. One approach to modeling the climate signal, i.e. the temperature resulting from climate as a function of depth, uses a 1-D finite-difference numerical forward model where all heat transport is assumed to be conductive. In one or more embodiments, the model space is discretized as a matrix of equally spaced nodes with thermal properties and the direction of heat flow specified for each node.

In one or more embodiments, the upper surface temperature, derived from the time-series data record of long-term air and-or soil temperature Tₛ(t), is fixed at a specified time interval for each time step, and each node exchanges heat with its eight closest neighboring nodes in the model while heat is conserved on the sides of the model space. As the model steps forward in time, the heat from the surface (climate signal) propagates downward into the subsurface.

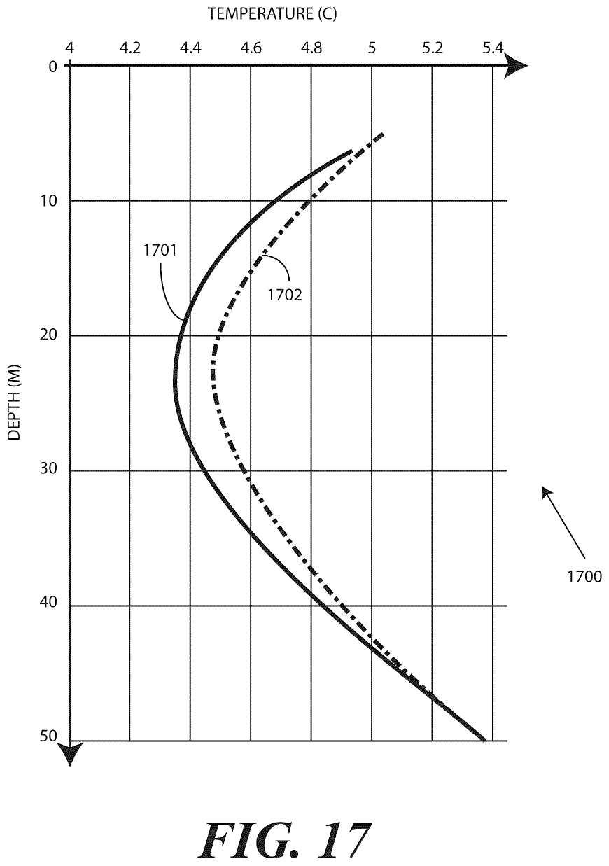

The temperature as a function of depth due to the climate signal is estimated and shown in FIG. 17. Turning briefly to FIG. 17, illustrated therein is a graph 1700 showing a model 1701 of the climate signal and a corresponding model 1702 of the climate signal and advection as a function of depth. From this information, turning now back to FIG. 5, at step 507 a digital filter can be designed to separate noise from the vertical profile temperature measurements collected at each measurement site. The residual in the measured temperature time-series, obtained at step 508, yields a vertical distribution of point temperature measurements of transient temperature due to geothermal heat flux (geothermal signal) assuming all heat transport in the material is conductive.

Once step 507 finds the contribution of the climate signal Tc (z) to the equilibrium temperature measured at a particular depth for a particular measurement site, the exemplary process goes on to find if there is significant advection (horizontal or vertical flow of fluids through the subsurface formation at the site), and if so to account for its influence in the modeling of T_{C}(z) described above. To detect and characterize heat transport by advection, one or more advective heat sensor(s) can be deployed at step 503 coincident with and to the same depth as the vertical temperature probes for each shallow-depth temperature survey or survey segment.

The advective heat sensor, described above with reference to FIG. 3, performs a thermal response test where the temperature disturbance (heat pulse) created by an artificial heat source of known power propagates spherically outward and is recorded by a group of temperature sensors spaced at a close distance apart, e.g. between one and five centimeters, and arrayed concentrically around the centrally located point heat source.

As described above, in one or more embodiments the advective heat sensor is contained within a perforated cylindrical housing so that fluids in the subsurface can flow freely around the sensor. The heat source generates a heat pulse that is recorded as time series data at each temperature sensor location.

If the temperature recorded by the array of temperature sensors as a function of time and distance from the heat source is the same, i.e. the heating front is propagating outward symmetrically, then this is used as an indication that heat transport is all or mostly by conduction. If the temperature recorded by the array of temperature sensors as a function of time and distance from the heat source is not the same, i.e. the heating front is propagating outward asymmetrically, then this is an indication of significant advection.

Moreover, the asymmetry of the heating front can be used to estimate the magnitude and direction of the fluid velocity in the formation. The fluid velocity can be incorporated into the 1-D numerical model described above and in combination with the formation density, specific heat capacity of the saturated medium, the temperatures measured at the site, and the Peclet number, can be used to model the effect of advection on the vertical temperature distribution resulting from the climate signal T_{C}(z).

At step 507, the temperature at shallow depth due to heating from geothermal heat flow T_{G}(z), which is the value of interest, can be found by quantifying the residual temperature for the vertical distribution of point temperature measurements after filtering out the modeled value of T_{C}(z) from T(z). Then, T_{G}(z) can be used to calculate the temperature gradient

$$\frac{δ {T}_{G}}{δ z}$$

due to the geothermal signal and

$$\frac{δ {T}_{G}}{δ z}$$

in combination with the thermal conductivity Kₕ(z) can be used to calculate geothermal heat flow q_{T}.

At step 509, area maps of geothermal heat flow at the depth of the temperature survey are produced from the results obtained in step 508 and may take the form of q_{T} isovalue curves. The maps may be printed on physical media or saved as computer image or data files.

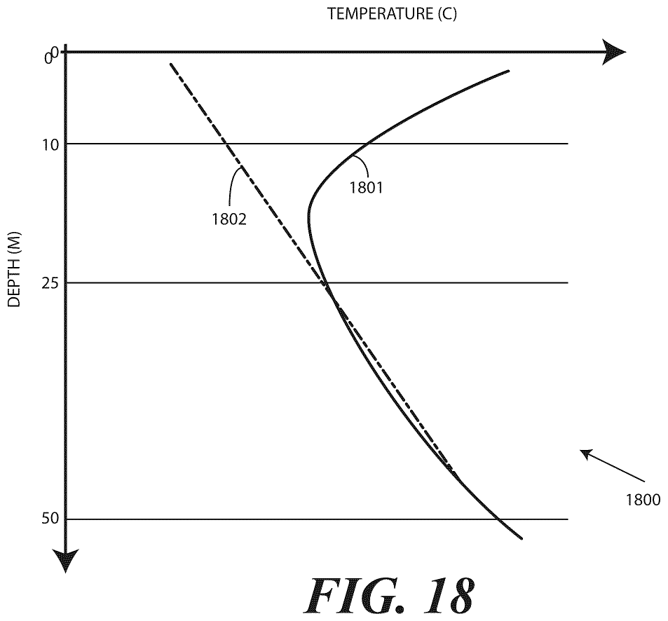

In the case that the maps do not indicate areas of high temperature or heat flow consistent with a commercial grade geothermal heat resource, then it may be sufficient to stop the method 500 at step 509. However, step 509 can be extended by creating a geologic model (1801), an example of which is shown in the graph (1800) of FIG. 18, for the survey area based on knowledge derived from geologic structure maps, geophysical surveys, drill records, or other sources.

In one or more embodiments, the model (1801) is matched to the vertical temperature distributions corrected for the climate signal, and the two are modified as necessary to achieve a satisfactory fit. To match the model (1801) with the corrected vertical temperature distributions (1802) for each measurement site, the vertical temperature distributions should first be examined to account for variable surface topography, which can cause a disturbance to the geothermal gradient due to the fact that increased surface area can permit increased heat loss, and that lateral heat flow can occur through inclined surfaces. After topographic corrections have been made, then in accordance with the invention the geologic model should be modified to match the measured and corrected vertical temperature distributions.

Referring again to FIG. 5, at step 510 the heat flow predicted by the geologic model calibrated using the vertical temperature distributions at the depth of the temperature survey can be projected downward to estimate heat flow at greater depth by incorporating into the geologic model a detailed model of thermal conductivity as a function of depth Kₕ(z). This task is different from simply taking measurements at step 505 because Kₕ(z) must now be determined over several kilometers of vertical distance as opposed to over the few meters sampled by the vertical profile temperature probe. Compaction of sediments, changes in lithology, and increases in seismic compressional wave velocity with depth can all be used to determine the required function.

Decision 511 determines, based on the vertical temperature distributions corrected and matched to the geologic model and its downward projection to depths where economic geothermal resources may be found, of where to drill or where to acquire subsurface rights or where to explore more fully with more expensive techniques, for instance utilizing THGs or geophysical surveys.

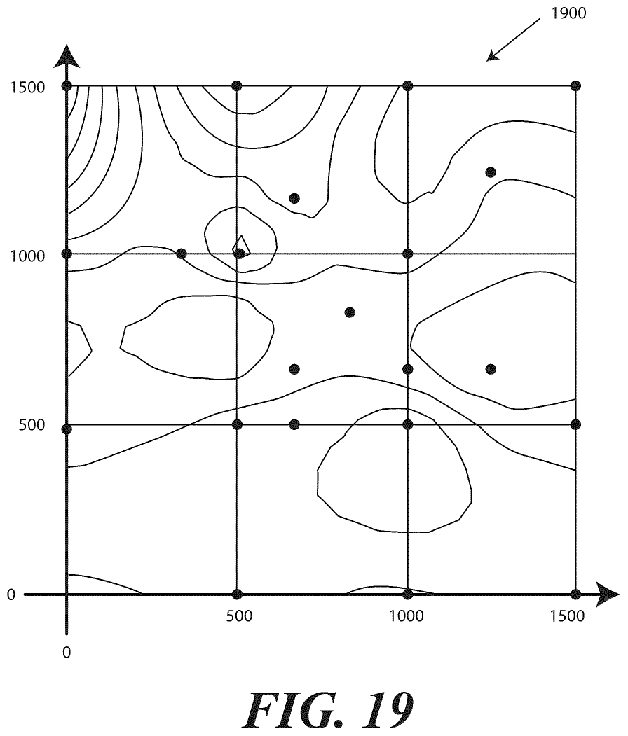

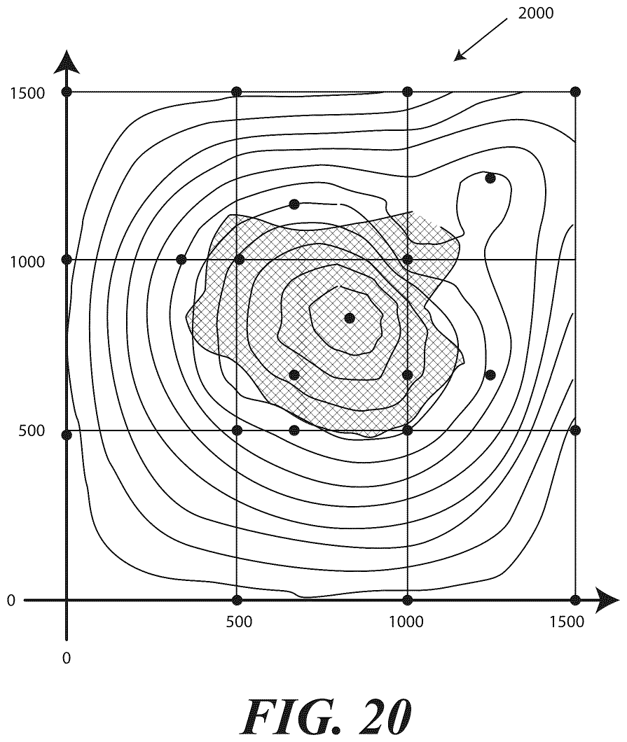

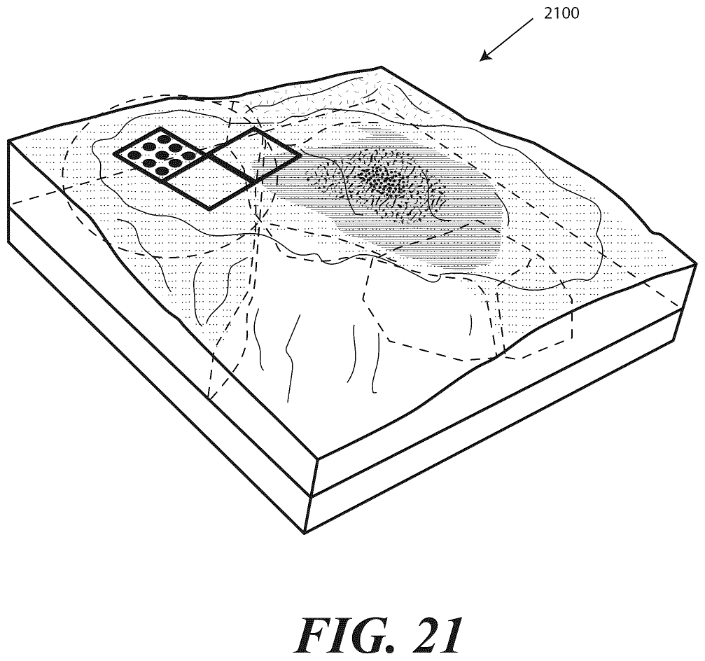

As illustrative examples, FIG. 19 shows a contour map 1900 made from example shallow-depth temperature survey data that shows normal heat flow, not indicative of a geothermal heat resource. By contrast, FIG. 20 shows a contour map 2000 made from example shallow depth temperature survey data that shows anomalously high heat flow indicative of a geothermal heat resource. FIG. 21 shows an example geological model 2100 to a depth of three kilometers that estimates geothermal heat flow based on the available subsurface data. Each can be produced at step 510 of FIG. 5.

Thus, as illustrated and described the method 500 of FIG. 5 offers significant benefits in the exploration and quantification of geothermal heat flux at shallow depths, addressing the limitations of traditional deep borehole surveys. By leveraging advanced sensing technologies, such as fiber optic temperature probes, and integrating computational modeling techniques, the method enables the isolation of geothermal heat signals from climate-driven surface heating effects, natural advection, and strain-induced distortions.

This approach eliminates the need for costly and logistically challenging deep boreholes, allowing for reliable heat flow measurements to be obtained from depths as shallow as four meters. Furthermore, the method enhances spatial sampling density, enabling the creation of detailed heat flow maps that visually represent geothermal energy resources across a geographic area.

These maps facilitate the identification of commercial-grade geothermal heat resources, reduce the risk of blind drilling, and support efficient resource exploration. Additionally, the corrected temperature profiles generated by the method can be used to calibrate geological models, enabling projections of geothermal heat flux at greater depths and providing insights into subsurface thermal dynamics. Other benefits will be obvious to those of ordinary skill in the art having the benefit of this disclosure.

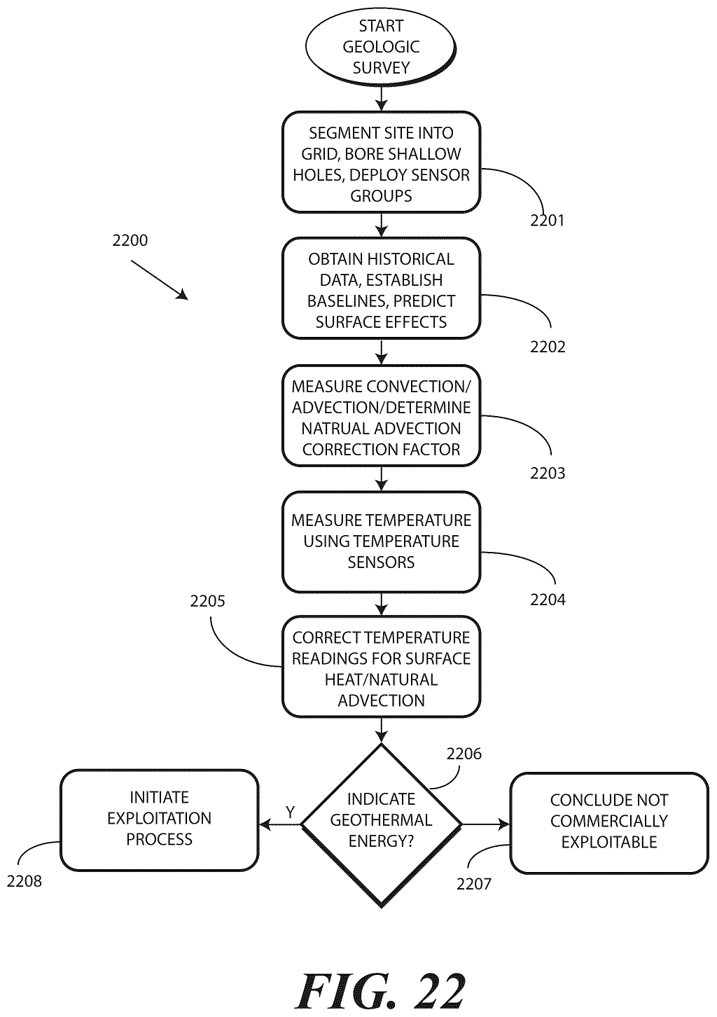

Turning now to FIG. 22, illustrated therein is another explanatory method 2200 in accordance with one or more embodiments of the disclosure. FIG. 22 presents a flowchart diagram illustrating a method 2200 for geothermal energy exploration. In this illustrative embodiment, the method comprises seven steps, namely step 2201, step 2202, step 2203, step 2204, step 2205, step 2207, and step 2208, as well decision 2206. When considered collectively, the method 500 provides a systematic approach to quantifying geothermal heat flux and determining the commercial viability of geothermal energy resources. Accordingly, each step and decision point are described below, with use cases and alternative implementations highlighted as appropriate.

In one or more embodiments, step 2201 segments the geographic area of interest into a grid or similar pattern based on geological data. At each measurement site within the grid, shallow boreholes are drilled, and sensor groups are deployed.

In one or more embodiments, each sensor group comprises a plurality of vertical profile temperature probes, a strain sensor, and a natural advection sensor. When in operation, this step 2201 ensures optimal spatial sampling density and comprehensive data collection. For example, in areas suspected of harboring blind geothermal systems, the grid can be densely spaced to detect subtle thermal anomalies. Alternatively, in regions characterized by uniform geology, the grid spacing can be increased to reduce costs while maintaining sufficient data coverage.

Subsequently, at step 2202, historical climate data is obtained to establish baselines for surface heating effects. In this step 2202, long-term records of surface temperature, precipitation, and other environmental factors are collected.

Thereafter, mathematical models are employed to predict the downward propagation of surface heating effects into the subsurface. This operation assists in isolating the geothermal heat signal from the climate-driven surface heating effects. For example, in regions exhibiting significant seasonal temperature variations, this step ensures that the climate signal is accurately modeled and subsequently corrected.

Turning now to step 2203, natural advection sensors are utilized to measure heat transport effects resulting from fluid movement within the subsurface. Accordingly, the collected data is analyzed to determine a natural advection correction factor, which quantifies the impact of advective heat transport on the recorded temperature profile.

In regions with notable groundwater movement, this step ensures that the geothermal heat signal remains undistorted. For example, the advective heat sensor can detect asymmetries in temperature disturbances induced by fluid flow, thereby allowing for precise remediation of advective effects.

Thereafter, at step 2204, vertical profile temperature probes are employed to measure temperature by recording time-series temperature data at closely spaced intervals along their vertical extent. As a result, these measurements capture both transient and equilibrium thermal conditions of the subsurface. In one or more embodiments, high-resolution temperature sensors, such as fiber Bragg grating (FBG) sensors, are leveraged to achieve millikelvin precision. For example, in regions with complex geological features, the high spatial resolution of the temperature probes facilitates the detection of subtle geothermal gradients.

Continuing, at step 2205, the recorded temperature data is adjusted for surface heating effects and natural advection using the models and correction factors established in steps 2202 and 2203. Additionally, if strain sensors are deployed, strain-induced errors are likewise addressed. This step 2205 serves to refine the temperature profiles to better represent the subsurface geothermal heat flux. For example, in areas with significant diurnal and seasonal temperature fluctuations, this step helps separate the geothermal signal from prevailing climate-driven variations.

At decision 2206, the corrected temperature profiles are analyzed to determine whether they suggest the presence of geothermal energy resources. In this embodiment, if the corrected temperature gradients exceed a predefined threshold, the method 2200 proceeds to step 2208. Otherwise, the method 2200 advances to step 2207. This decision point plays a significant role in evaluating the commercial viability of the surveyed area. For example, in regions with substantial geothermal potential, the threshold can be adjusted to focus on areas with a strong probability of yielding commercially viable resources.

In one or more embodiments, step 2207 concludes that the geothermal energy resources are not commercially exploitable if the corrected temperature profiles do not indicate sufficient potential. Under these conditions, the method 2200 halts exploration for the current site and then may be applied to alternative sites within the geographic area of interest. Thus, this step 2207 minimizes resource expenditure by redirecting exploration efforts to locations with greater promise. For example, in areas characterized by low heat flow, this step 2207 ensures that exploration resources are efficiently allocated.

Conversely, in step 2208, if the corrected temperature profiles indicate the presence of commercially exploitable geothermal energy resources, the exploitation process is initiated. In this embodiment, the method 500 includes further exploration, drilling of confirmation wells, and the development of geothermal energy production facilities. As a result, this step 2208 supports the efficient utilization of resources and expedites the transition from exploration to energy production. For example, in regions with confirmed geothermal resources, this step facilitates prompt progression to full-scale energy production.

Moreover, in various embodiments, the method 2200 as described in FIG. 22 is adaptable to a myriad of geological and operational conditions. For example, the method may be implemented for blind geothermal systems, where the approach detects thermal anomalies even in the absence of surface expressions such as hot springs or fumaroles.

Additionally, the method 2200 offers a cost-effective exploration alternative by leveraging shallow temperature measurements, thereby reducing the need for deep borehole surveys and associated logistical challenges. Furthermore, the grid-based approach enables high spatial sampling density, thereby improving the accuracy of geothermal resource assessments. In addition, the method 2200 can also be applied to environmental monitoring by studying subsurface temperature variations in areas affected by climate change or human activities.

Thus, alternative implementations are readily apparent, including variations in borehole depth, modifications to grid spacing based on local geological features, and the incorporation of additional sensors to enhance data collection—thereby ensuring the method's broad applicability to diverse exploration scenarios.

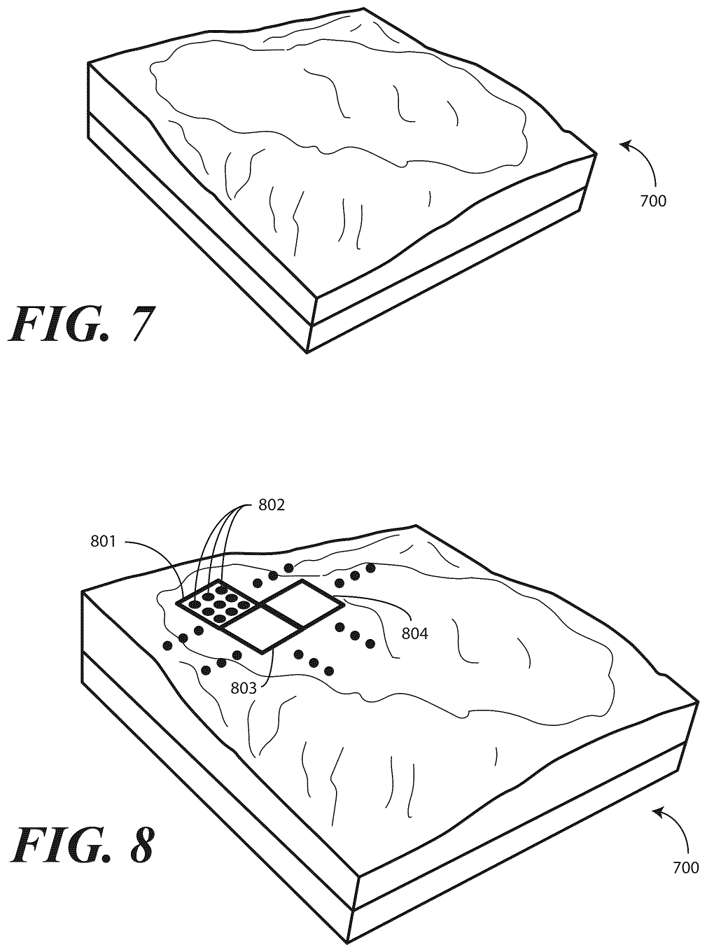

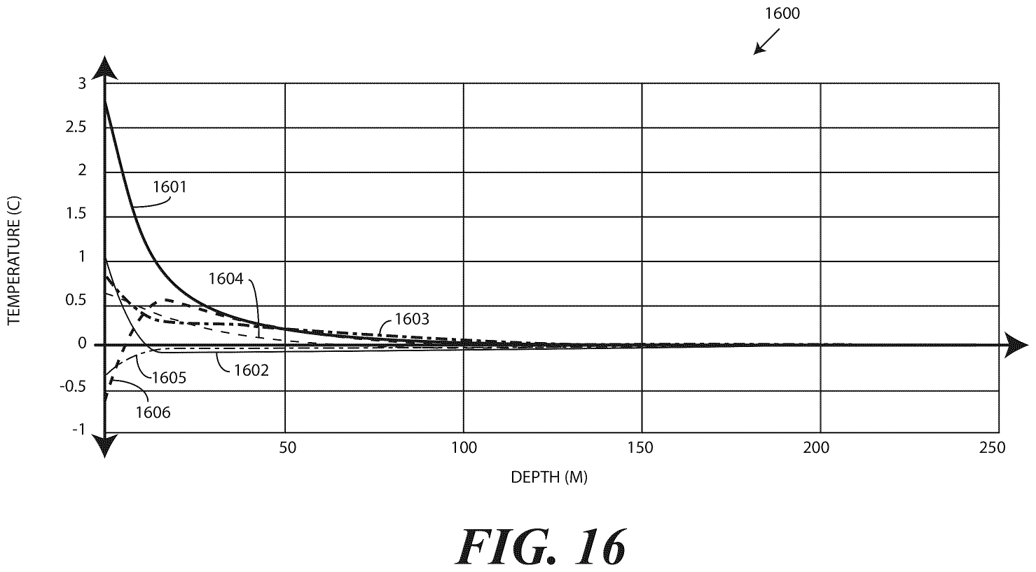

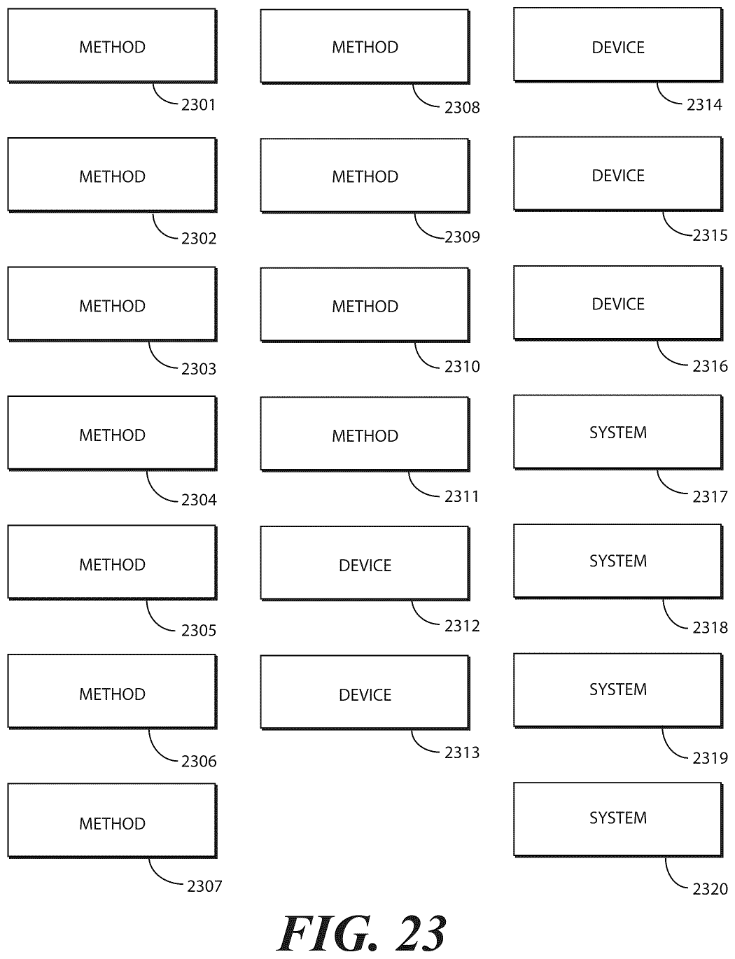

Turning now to FIG. 23, illustrated therein are various embodiments of the disclosure. The embodiments of FIG. 23 are shown as labeled boxes in FIG. 23 due to the fact that the individual components of these embodiments have been illustrated in detail in FIGS. 1-22, which precede FIG. 23. Accordingly, since these items have previously been illustrated and described, their repeated illustration is no longer essential for a proper understanding of these embodiments. Thus, the embodiments are shown as labeled boxes.

At 2301, a method for quantifying shallow earth geothermal heat flux from subsurface energy sources comprises defining a plurality of measurement sites along a geographic area of interest. At 2301, the method comprises, at each measurement site, deploying at least one electronic sensor group comprising a plurality of vertical profile temperature probes each comprising a stacked plurality of temperature sensors and a natural advection sensor.

At 2301, the method comprises recording, using the stacked plurality of temperature sensors, a vertical distribution time-series of temperature measurements. At 2301, the method comprises correcting the vertical distribution time-series of temperature measurements for natural advection measured by the natural advection sensor and conductive heating from a surface of the geographic area of interest to obtain a corrected temperature gradient.

At 2302, the deploying of 2301 comprises positioning the plurality of vertical profile temperature probes between four and fifteen meters beneath the surface of the geographic area of interest. At 2303, the recording the vertical distribution time-series of temperature measurements at 2301 occurs for a predefined duration occurring after identification of a thermal equilibrium following a disturbance event resulting from the deploying the plurality of vertical profile temperature probes.

At 2304, the method of 2301 further comprises determining an equilibrium temperature for each vertical profile temperature probe of the plurality of vertical profile temperature probes. At 2304, the determining the equilibrium temperature for the each vertical profile temperature probe comprises averaging the time-series of temperature measurements. At 2305, the correcting the vertical distribution time-series of temperature measurements of 2304 comprises correcting the equilibrium temperature for the natural advection measured by the natural advection sensor and the conductive heating from the surface of the geographic area of interest.

At 2306, the deploying the at least one electronic sensor group of 2301 further comprises deploying a strain sensor. At 2306, the correcting the vertical distribution time-series of temperature measurements further comprises correcting for strain measured by the strain sensor.

At 2307, the method of 2301 further comprises generating a heat flow map for the geographic area of interest resulting from geothermal heat flux from the corrected temperature gradient. At 2307, the heat flow map indicates a presence of commercial-grade geothermal heat resources when the corrected temperature gradient exceeds a predefined threshold.

At 2308, the method of 2301 further comprises separating a contribution of geothermal heat flux from another contribution of heating of the surface of the geographic area from the time-series of temperature measurements to obtain a magnitude of the geothermal heat flux. At 2309, the plurality of vertical profile temperature probes of 2301 comprises at least three vertical profile temperature sensors each having at least two fiber optic sensors arranged in a fiber Bragg grating.

At 2310, the method of 2301 further comprises obtaining a multi-year surface temperature record for the geographic area and, with a numerical heat-transfer model, generating a depth-dependent function of temperature representing the conductive heating and convective heating upon the surface of the geographic area of interest on subsurface temperatures. At 2311, the temperature gradient of 2301 corresponds to a temperature signal generated by a geothermic energy source.

At 2312, a device comprises a device housing, a fiber Bragg grating comprising a plurality of optical fiber sensors and carried by the device housing, a fiber Bragg grating interrogator optically coupled to the optical fiber sensors, and a data logger operatively coupled to the fiber Bragg grating interrogator. At 2312, the fiber Bragg grating interrogator queries the fiber Bragg grating to determine a vertical temperature distribution detected by the fiber Bragg grating that is recorded to a non-transient, computer readable medium by the data logger.

At 2313, the device housing of 2312 is between one and five meters in length. At 2314, the plurality of optical fiber sensors of 2312 comprises at least two optical fiber sensors. At 2315, the device housing of 2312 terminates at a frustoconical head.

At 2316, the plurality of optical fiber sensors of 2312 is positioned along the device housing at predetermined intervals to generate temperature measurements at discrete intervals along a length of the device housing. At 2317, the device of 2312 is situated between four and fifteen meters below a site of interest so as to record a time-series temperature record to determine geothermal heat flux.

At 2318, a system for evaluating geothermal heat flux from geothermal energy sources at a geographic area of interest comprises a plurality of vertical profile temperature probes each comprising a vertically fiber Bragg grating, a strain sensor, a natural advection sensor, and one or more processors operable with the plurality of vertical profile temperature probes, the strain sensor, and the natural advection sensor. At 2318, the one or more processors are configured to adjust vertical profiles of temperature measurements for strain measured by the strain sensor and natural advection measured by the natural advection sensor to determine a heat flow quantity resulting from a geothermal heat resource.

At 2319, the one or more processors of 2318 are further configured to adjust the vertical profiles of temperature measurements as a function of solar heating of a surface of the geographic area of interest. At 2320, the one or more processors of 2319 are further configured to generate a heat flow map indicating a likelihood of existence of the geothermal energy sources for the geographic area of interest from the heat flow quantity.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, the present disclosure relates generally to methods, systems, and devices for geothermal exploration, specifically focusing on the quantification of geothermal heat flux using vertical temperature profiles measured at shallow depths. The described approach leverages advanced sensing technologies, such as fiber optic sensors, to address challenges associated with traditional deep borehole surveys, offering a cost-effective and scalable alternative for subsurface evaluation. By isolating geothermal heat signals from surface temperature fluctuations, the disclosed methods provide improved techniques for assessing geothermal resources, enabling broader exploration and more efficient resource utilization.

The embodiments described herein are presented for illustrative purposes and are not intended to impose limitations. The examples provided aim to enhance comprehension of the described subject matter and its applications but do not confine the scope of the claims. Certain details, such as commonly used components or widely recognized techniques, may be omitted for clarity, as they are readily understood by those skilled in the art. Additionally, various modifications, rearrangements, or substitutions of components and steps may be implemented without deviating from the principles and scope defined by the claims.

For instance, in one embodiment the device housing of a vertical profile temperature probe may be constructed from lightweight, durable materials such as aluminum or carbon fiber to ensure ease of deployment and resistance to environmental conditions. Alternatively, the housing could be made from high-strength polymers or composite materials to reduce manufacturing costs while maintaining structural integrity.

Similarly, the fiber Bragg grating (FBG) may include a varying number of optical fiber sensors, ranging from two to fifty sensors, depending on the required resolution and depth of measurement. These sensors could be spaced at intervals of five centimeters to twenty-five centimeters along the length of the housing to accommodate different survey requirements.

The fiber Bragg grating interrogator may be configured to operate at varying wavelengths, allowing for enhanced precision in temperature measurement or compatibility with different environmental conditions. The data logger could be equipped with wireless communication capabilities, enabling real-time data transmission to remote monitoring stations, or the data logger could utilize high-capacity storage for extended field deployments.

The device housing may terminate in a frustoconical head designed for penetration into soft soils, or the housing could feature a reinforced tip for deployment in rocky or compacted terrains. Additionally, the device may include optional external features such as a protective sheath to shield the optical fibers from mechanical strain or environmental contaminants, ensuring long-term reliability. In another embodiment, the device could be integrated with modular components, allowing for the addition of supplementary sensors, such as strain meters or advective heat sensors, to expand its functionality for specific geothermal exploration scenarios.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for quantifying shallow earth geothermal heat flux from subsurface energy sources, the method comprising:
defining a plurality of measurement sites along a geographic area of interest;
at each measurement site, deploying at least one electronic sensor group comprising:
a plurality of vertical profile temperature probes each comprising a stacked plurality of temperature sensors; and
a natural advection sensor;
recording, using the stacked plurality of temperature sensors, a vertical distribution time-series of temperature measurements; and
correcting the vertical distribution time-series of temperature measurements for natural advection measured by the natural advection sensor and conductive heating from a surface of the geographic area of interest to obtain a corrected temperature gradient.

2. The method of claim 1, wherein the deploying comprises positioning the plurality of vertical profile temperature probes between four and fifteen meters beneath the surface of the geographic area of interest.

3. The method of claim 1, wherein the recording the vertical distribution time-series of temperature measurements occurs for a predefined duration occurring after identification of a thermal equilibrium following a disturbance event resulting from the deploying the plurality of vertical profile temperature probes.

4. The method of claim 1, further comprising determining an equilibrium temperature for each vertical profile temperature probe of the plurality of vertical profile temperature probes, wherein the determining the equilibrium temperature for the each vertical profile temperature probe comprises averaging the vertical distribution time-series of temperature measurements.

5. The method of claim 4, wherein the correcting the vertical distribution time-series of temperature measurements comprises correcting the equilibrium temperature for the natural advection measured by the natural advection sensor and the conductive heating from the surface of the geographic area of interest.

6. The method of claim 1, wherein:
the deploying the at least one electronic sensor group further comprises deploying a strain sensor; and
correcting the vertical distribution time-series of temperature measurements further comprises correcting for strain measured by the strain sensor.

7. The method of claim 1, further comprising generating a heat flow map for the geographic area of interest resulting from geothermal heat flux from the corrected temperature gradient, wherein the heat flow map indicates a presence of commercial-grade geothermal heat resources when the corrected temperature gradient exceeds a predefined threshold.

8. The method of claim 1, further comprising separating a contribution of geothermal heat flux from another contribution of heating of the surface of the geographic area from the vertical distribution time-series of temperature measurements to obtain a magnitude of the geothermal heat flux.

9. The method of claim 1, wherein the plurality of vertical profile temperature probes comprises at least three vertical profile temperature sensors each having at least two fiber optic sensors arranged in a fiber Bragg grating.

10. The method of claim 1, further comprising obtaining a multi-year surface temperature record for the geographic area and, with a numerical heat-transfer model, generating a depth-dependent function of temperature representing the conductive heating and convective heating upon the surface of the geographic area of interest on subsurface temperatures.

11. The method of claim 1, wherein the corrected temperature gradient corresponds to a temperature signal generated by a geothermic energy source.

12. A device, comprising:
a device housing;
a fiber Bragg grating comprising a plurality of optical fiber sensors and carried by the device housing;
a fiber Bragg grating interrogator optically coupled to the optical fiber sensors; and
a data logger operatively coupled to the fiber Bragg grating interrogator;
wherein the fiber Bragg grating interrogator queries the fiber Bragg grating to determine a vertical temperature distribution detected by the fiber Bragg grating that is recorded to a non-transient, computer readable medium by the data logger.

13. The device of claim 12, wherein the device housing is between one and five meters in length.

14. The device of claim 12, wherein the plurality of optical fiber sensors comprises at least two optical fiber sensors.

15. The device of claim 12, wherein the device housing terminates at a frustoconical head.

16. The device of claim 12, wherein the plurality of optical fiber sensors is positioned along the device housing at predetermined intervals to generate temperature measurements at discrete intervals along a length of the device housing.

17. The device of claim 12, wherein the device is situated between four and fifteen meters below a site of interest so as to record a time-series temperature record to determine geothermal heat flux.

18. A system for evaluating geothermal heat flux from geothermal energy sources at a geographic area of interest, the system comprising:
a plurality of vertical profile temperature probes each comprising a vertically fiber Bragg grating;
a strain sensor;
a natural advection sensor; and
one or more processors operable with the plurality of vertical profile temperature probes, the strain sensor, and the natural advection sensor;
wherein the one or more processors are configured to adjust vertical profiles of temperature measurements for strain measured by the strain sensor and natural advection measured by the natural advection sensor to determine a heat flow quantity resulting from a geothermal heat resource.

19. The system of claim 18, wherein the one or more processors are further configured to adjust the vertical profiles of temperature measurements as a function of solar heating of a surface of the geographic area of interest.

20. The system of claim 19, wherein the one or more processors are further configured to generate a heat flow map indicating a likelihood of existence of the geothermal energy sources for the geographic area of interest from the heat flow quantity.
